(19) United States
(12) Patent Application Publication
(10) Pub. No.: US 2026/0019407 A1
(43) Pub. Date: Jan. 15, 2026

(54) BATTLESPACE ENCRYPTED DATA NETWORK USING A DETERMINISTIC METHOD FOR GENERATING AN EPHEMERAL CRYPTOGRAPHIC KEY SUPPLIED TO ENCRYPTION/ DECRYPTION SYSTEMS AND SEPARATE KEY ELEMENTS AS A SECURE CRYPTOGRAPHIC SYSTEM

(71) Applicant: Jonathan Carr, Vienna, VA (US)

(72) Inventor: Jonathan Carr, Vienna, VA (US)

(73) Assignee: Blackspire, LLC, Vienna, VA (US)

(21) Appl. No.: 18/773,569

(22) Filed: Jul. 15, 2024

(51) Int. Cl. H04L 9/40

(52) U.S. Cl. CPC H04L 63/0442

(57) ABSTRACT

A deterministic encryption key generating method along with a cryptographic system is disclosed as a component in a battlespace management system or platform within the battlespace. The systems method uses the intersection of an equation representing a polynomial or two-variable quadratic (PQ-Equation) with a secure and secret 3-dimensional mathematical geometric shape, or manifold, to generate an ephemeral symmetric encryption key. Digital objects, files, and data can be cryptographically secured using this process with a unique per-file or per-data object key, which is destroyed after each use. The process combines coefficients of a PQ-Equation mapped onto the manifold to create or recreate the key. PQ-Equation coefficients are stored within the protected file, accessible via the client and transmitted to the computational server possessing the secret manifold. The client device possesses no knowledge of the manifold and the computational server receives no knowledge of the digital object contents, ensuring the confidentiality and integrity of the information being protected allowing the digital object to be securely stored or transmitted over a network or Internet with per protected data object defined access policies to the decryption key.

### CROSS-REFERENCE TO RELATED APPLICATIONS

This application claims the priority of U.S. provisional patent application 63/526,957, filed Jul. 14, 2023, which is incorporated herein by reference, this application being timely filed on Monday Jul. 15, 2024.

### COPYRIGHT NOTICE

Portions of the disclosure of this patent document contain material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### FIELD OF THE INVENTION

The present invention relates to a battlespace management system utilizing a cryptographic system using polynomial or quadratic coefficients and a multi-variable geometric surface(s) to generate a non-predictable but deterministic ephemeral asymmetric cryptographic key, which retains the full key-space and highest entropy, and is highly resistant to cryptographic analysis and brute-force attacks. The cryptographic system provides a way to apply access policies to encrypted data objects to aid in the management distribution of the cryptographic key to more securely control the decryption of the data object while also providing a wider range of applicable functions and resulting products across multiple platforms in the battlespace. This ensures that data on the network is secure and that orders and responses can be verified as originating from a command authority and/or received and understood by command and control components.

### REFERENCES

For the convenience of the reader, the publications referred to in the specification are listed below. In the specification, the patents are referred to by their patent numbers and the identifiers within parentheses refer to respective publications.

| Patent No. | Issue Date | Inventors |
|---|---|---|
| 5,963,646 | October 1999 | Fielder et al. |
| 7,787,623 | October 2007 | Koichiro et al. |
| 8,311,215 | September 2010 | Koichiro et al. |
| 11,108,753 B2 | August 2021 | Murray et al. |

(Ref A) Dworkin, M., Barker, E., Nechvatal, J., Foti, J., Bassham, L., Roback, E. and Dray, J. (2001), Advanced Encryption Standard (AES), Federal Inf. Process. Stds. (NIST FIPS 197), National Institute of Standards and Technology, Gaithersburg, MD, (online), https://doi.org/10.6028/NIST.FIPS.197
(Ref B) Elaine Barker, Allen Roginsky, Richard Davis, (2020), NIST Special Publication 800-133 Revision 2. Recommendation for Cryptographic Key Generation. (online), https://nvlpubs.nist.gov/nistpubs/SpecialPublications/NIST.SP.800-133r2.pdf
(Ref C) Elaine Barker, John Kelsey (2015), NIST Special Publication 800-90A Revision 1. Recommendation for Random Number Generation Using Deterministic Random Bit Generators. (online), https://nvlpubs.nist.gov/nistpubs/SpecialPublications/NIST.SP.800-90Ar1.pdf
(Ref D) Elaine Barker, (2020), NIST Special Publication 800-57 Part 1 Revision 5. Recommendation for Key Management: Part 1—General. (online) https://nvlpubs.nist.gov/nistpubs/SpecialPublications/NIST.SP.800-57pt1r5.pdf
(Ref E) Ruiten E., (2021, January 15). A Cryptosystem Based on Algebraic Surfaces. Universiteit Utrecht

### BACKGROUND OF THE INVENTION

Information systems and the digital information that they contain are considered to be critical assets that require protection. This need for security is never more prevalent than when that data is being used in a battlespace. Lives depend on information. This has been true for all time. Intelligence is critical to planning and accurate assessment and accuracy in battles and trust/authentication of data sources are critical to command and control (C2) and its Intelligence, Surveillance and Reconnaissance (ISR) mission. The advent of electronic communications and digital networks has pushed rapid and substantial sharing of such data even further by creating new data sharing efficiencies; however, these technologies increase security risks of accidental information exposure when information can be stored and accessed from anywhere and similarly attacked by an adversary from anywhere. Secure, robust, hardened communications are critical to all C2 systems and subsystems.

What makes this information so vital and available is the rapid, real time transfer of the data between these disparate systems in various ways, ranging from satellite, to wireless, to cellular, to more traditional hardwired and terrestrial networks and similar communications networks. But each system, along with each transmission point, presents opportunities for an adversary to exploit the data or deny communications. Every time data moves from one system to another, the number of attack vectors increases—giving adversaries more opportunities to compromise the data. These adversaries are bringing sophisticated techniques and methods to attack data on the battlefield. Their technology advances move quickly—in contrast with the sometimes slow acquisition processes followed by U.S. and allied militaries. The result is compromised, untrusted, or degraded data—which can damage the warfighter's understanding of the battlefield situation and limit their ability to make the most effective decisions. A light, flexible, ubiquitous encryption service that fits within the best elements of zero trust systems for securing those systems and their data across the space is necessary.

The data security issues stretch outside of the traditional battlespace data arena as well. The desire to have unhindered and ubiquitous access to data throughout the planning and decision making process, whether by a human using a desktop computer, a laptop, or a mobile device, or an automated computing system or artificially intelligent systems places stresses on implementing secure information processes to permit the widest available and most accessible use of stored information securely as needed by all levels of command. A digital battlespace encompasses many systems-of-systems to accomplish this goal, ranging from handheld devices to enterprise-level intelligence and data architectures. As these technologies become increasingly connected to each other as part of modern warfighting systems, they provide more data and more mobility-both key to achieving overmatch in the battlespace and accurate and rapid planning to achieve the overmatch. The digital battlespace demands that digital data and electronic information, referred herein to as Data Objects (DOs), be communicated and/or held securely across this variety of devices and computer systems, networks, the distributed computer networks (aka cloud networks), terrestrial and wireless networks, as well as other similar data systems, and must be rapidly and securely accessible. While these systems grow more connected, it becomes more critical to make sure they are as secure as possible to protect the system as a whole. That's because, in the digital battlespace, information superiority wins. But this influx of data comes with increased vulnerabilities for adversaries to exploit.

This accessibility must be efficient and secure and commonly made available through a secure network access or an access platform that is easily shared using a variety of communications protocols, systems, emails, message services, and file sharing services in a secure system to share modular, scalable, flexible solutions to seize decision advantage faster and thwart adversaries attacks. The devices that create, use, transmit or receive the data object can be mobile or stationary ranging in size from individual weapons systems scaling up to enterprise-level intelligence and data architectures.

Ultimately, to support independent yet coordinated decisions and effective action, data and information needs to go where the warfighter is: on the battlefield, in the air, on or below the sea, in space or wherever the mission leads securely and quickly and then back to their respective command and control elements. For example, satellite imaging data and information was once available only available to satellite data analysts collected by an enterprise level agency and retrained during planning. This data is now increasingly being relayed in real time directly to operators in the field, empowering them with more data and context for making critical mission decisions.

While unhindered and ubiquitous access is desired for decision makers in all levels of the chain of command and multi-directional data flows for warfighters and their systems to accurately and rapidly communicate needed information to commanders, the data owner or recipient will have special handling policies and security needs for the information transmitted, received and stored; thus, making data security management complicated, cumbersome, ineffective or, in the worst case, ignored.

In addition to overall information security requirements, there is also a need derived from organizational policies for protecting proprietary or classified government data based on agency and organizational policies for access. Maintaining or enforcing these policies becomes even more challenging with highly mobile communication chains from decision makers and warfighters as part of a C2 or command, control, computer, communications (C4) intelligence, surveillance and reconnaissance (ISR) system. The actors in this chain desire an almost pervasive demand for digital access at the cost of equally pervasive vectors to compromise the data flow. The information used by these systems requires protection when at rest, when being processed within a protected facility, and when transported or transmitted from one location to another. Threat actors can bring significant harm to the systems should they have physical or logical access to stored data; or inadvertently release owing to a loss or spill of data due to mishandling of the data objects or a misconfigured networks or other means of access to the system. Security for the data objects together with redundancy in access as well as monitoring and detection subsystems work together with robust encryption to secure the systems and minimize the effect of any compromise and thereby provide a robust, secure command, control, communication and computer (C4) system across multiple platforms.

Cryptography provides a base layer of protection and is often used to protect information from unauthorized disclosure, to detect unauthorized modification, and to authenticate the identities of system entities (e.g., individuals, organizations, devices or processes). Cryptography is particularly useful when data transmission or entity authentication occurs over communications networks for which physical means of protection (i.e., physical security techniques) are often cost-prohibitive or even impossible to implement. Thus, cryptography is widely used when sensitive information is transmitted over networks in a battlespace. Cryptography provides a layer of protection both against attacks to intercept data and by scrambling the data and preventing those who may have physical or logical access to stored data, but not the authorization to know or modify the data, cannot make use of it. The challenge with cryptography is providing a meaningful and efficient way to secure the data without encumbering access to or transmission of the data, which is accessible by authorized users and computing processes, and is not restricted by the computing or electronic device used, while ensuring that the available key protection system is robust in its key space and can withstand sustained attempts via the most cutting edge efforts to compromise the encryption.

The invention improves the existing state of the art providing a more secure, efficient, compact, cryptographic and policy management solution. This include in part providing an improved secure, robust encryption system and method of key provisioning and policy management to provide agil, secure cryptography combined with policy management techniques to rapidly encrypt and decrypt data across multiple platforms in a fashion that is agnostic as to the cryptographic protocol, permitting wide ranging cross platform implementation and compatibility, ideal for battlespace management systems and sub-systems in a fashion that outperforms existing solutions and systems.

Cryptography, such as that used by the exemplary embodiments shown, can be used to provide three major types of protection to data: confidentiality, integrity, and source authentication. Confidentiality protection safeguards data from unauthorized disclosure; integrity protection provides mechanisms to detect unauthorized data modifications; and source authentication protection provides assurance that the protected data came from an authorized entity. Data encryption technology can be classified generally within two methods: symmetric-key cryptography and asymmetric encryption methods. Cryptography further generally relies on two basic components: an algorithm, or cryptographic method, and, often used but sometimes optional, cryptographic key (Kᵢ). The algorithm is a mathematical process and the key is a parameter used by that process.

Symmetric-key cryptography is an encryption method where only one key, which must be kept secret, is used to encrypt and decrypt a message. This method is commonly used in banking and data storage applications to protect stored data. Examples of symmetric-key cryptographic algorithms include for example, but are not limited to, Data Encryption Standard (DES), the Rivest's Cipher (RC) family of algorithms, the Rijndael algorithm—also known as the Advanced Encryption Standard (AES)—Blowfish, International Data Encryption Algorithm (IDEA), and others.

Asymmetric cryptography or public key cryptography differs from symmetric-key cryptography in that a public key—which may be known to others, is used to encrypt a message, and a private key, which remains secret, can decrypt the message, while, with symmetric key encryption, no key(s) is publicly shared. Examples of asymmetric encryption algorithms include, for example but are not limited to Rivest-Shamir-Adleman (RSA) and Elliptic Curve Cryptography (ECC). Both asymmetric encryption methods generate a public and private key and is generally based on mathematical properties of prime numbers. In both cases, proper management of cryptographic keys is essential to the safe use of encryption. Loss of the keys can lead to loss of data and exposure of an organization to violations of compliance requirements.

Mathematical algorithms, human interaction, natural processes and machine state properties are used to produce bits of information that form the key. The output of a Random Bit Generator (RBG), the derivation of a key from another key, and the derivation of a key from a password, are methods used to transform the bits of information into cryptographic keys.

Generally, all keys are based directly or indirectly on the output of an approved RBG, for instance, that which is described by NIST Special Publication (SP) 800-133 Revision 2, Recommendation for Cryptographic Key Generation, (NIST SP 800-133 Rev. 2) (Ref B herein above), which is incorporated herein by reference; or a Deterministic Random Bit Generator (DRBG), for instance that which is described in NIST SP 800-90A Rev. 1 (Ref C herein above) which is also incorporated by reference herein, or a Pseudo-Random Number Generator (PRNG) or similar algorithm or engine. A DRBG or PRNG algorithm that produces a sequence of bits from an initial value is determined by a seed, which is determined from the output of the randomness source. Once the seed is provided and the initial value is determined, the DRBG is said to be instantiated and can be used to produce output. As long as the seed is kept secret, and the algorithm is well designed, the bits output by the DRBG will be unpredictable, up to the instantiated security strength of the DRBG.

Symmetric keys can be produced by combining multiple keys and other data, as shown in NIST SP 800-133 Rev. 2 which is incorporated by reference. When symmetric keys (K₁, . . . Kₙ) are generated and/or established independently, they can be combined within a key-generating module to form the input key, Kᵢ. Other data (D₁, . . . Dₘ) can be generated using methods that ensure their independence from Kᵢ and can be combined with Kᵢ to generate a new key.

A modem cryptographic method, or cipher widely in use is the Advanced Encryption Standard (AES), NIST FIPS 197, November 2001, Advanced Encryption Standard (AES), (Ref A listed above) which is herein incorporated by reference and used in the exemplary embodiment of the instant invention. The AES standard specifies the Rijndael algorithm, which is a symmetric block cipher algorithm. The AES cipher uses an input key to generate a set of keys by the key expansion routine. Plaintext (P) data, which can be a message, data file or other information, along with the cryptographic key (Kᵢ) is inputted into the AES cipher algorithm (E) to transform the information into Ciphertext (C), through the encryption process C=E(Kᵢ, P). Encrypted information is unreadable without passing the Ciphertext and Kᵢ into the AES cipher inverse algorithm (D), transforming the Ciphertext back into Plaintext; the decryption processes defined as P=D(Kᵢ, C). The cryptographic key used to encrypt P to C and C to P is the same key; therefore, Kᵢ is symmetric.

Key information must be protected for the security services to be “meaningful.” NIST SP 800-57 Part 1 Rev. 5, Recommendation for Key Management: Part1—General. One method to store and manage cryptographic keys is by using a Cryptographic Key Management System (CKMS). Within a CKMS, all keys are stored in a database, whose security is reliant on implemented security protocols established by the user and organization. Although a CKMS can be secure when proper security is implemented, the fact that a CKMS stores all cryptographic keys for the organization, makes CKMS's attractive targets for improper actors, criminals, and hackers. Computing systems with zero-day vulnerabilities or unpatched systems result in weakened security, providing opportunities for the actors to access the CKMS and steal the keys.

An example of typical per file encryption in prior art is the deterministic key generators and CKMS solution that maps a precomputed key or seed, like that shown in U.S. Pat. No. 5,963,646, to an object, such as a file or digital information. The '646 patent shows a prior art solution in that the disclosed encryption method is a method and system for generating a deterministic but non-predicable symmetric encryption key. This method combines two values, bits of a constant value or message, e.g. Other Data, logically, cryptographically and/or algebraically combined with the bits of a secret plural bit sequence (E-KEY SEED). Although the E-KEY SEED is held secret, the E-KEY SEEDs are stored in a key directory and mapped to an object to be encrypted or decrypted. Because the data file is mapped to an E-KEY SEED stored in a database, or CKMS, the encrypted file cannot be easily transmitted to a third party without a method to share the encryption key or provide access to the database storing the E-KEY SEED. A shortcoming of this method is the size of key space that is practically available for use. AES 256 comes in several standards, 128-bit, 192-bit and 256-bit implementations. The theoretical maximum storage space for the full AES 256 key space is approximately 1.5E65 terabytes. Although this method uses Other Data in an attempt to provide additional system entropy computed with the E-KEY SEED, an inherent weakness in this system is that Other Data is derived from the bits of the message being protected and therefore, is known. NIST SP 800-133 Rev. 2 allows for Other Data to be used to compute Kᵢ when Other Data is independent from the key. In this case, the bit of the message is known and is not independent when combined with the E-KEY SEED, which results in a weakening of the key and decreasing the encryption system entropy. To retain maximum system entropy, one E-KEY SEED must be mapped to one file. In large file systems, the number of E-KEY SEEDS must grow with the number of files in the system. Storage and processing limitation can force one E-KEY SEED to be used for many files, where key reuse decreases system entropy and weakens the key over time. Additionally, E-KEY SEEDS are derived from a single ACTIVATION CODE. As system entropy and randomness decreases, there is increased probability that the ACTIVATION CODE can be computed by improper actors, criminals and hackers, which would permit the calculation of all E-KEY SEEDS used by the method. Therefore, no meaningful barrier against discovery of the E-KEY SEED and the ACTIVATION CODE can be provided for this encryption system. The ease in discovery makes this method/system impracticable and dangerous for the use in high security environments.

U.S. Pat. No. 11,108,753 B2 discloses an encryption system in which the disclosed method uses a per-file key (FK) management and encryption methodology. This method generates a per-file symmetric key FK and secures FK using a wrapping key (WK). WK can be configured to be shared between files of a directory or a directory tree. File and directory access configurations are contained in a security/configuration policy and CKMS, managed by a policy engine. WK's are stored in a key manager, securely communicating with the policy engine. This method permits the generation of a single FK per file, allowing per file encryption. However, as the number of files, directories, users and resources requiring file access increase on the storage system the number of FK's and WK's will exponentially increase. Storage and computing limitations will limit the number of possible keys for per-file encryption to significantly less than the 2²⁵⁶ potential key space. As the number of users and resources increase within the system sharing the same access policy, the WK key will be mapped one to many, which will decrease entropy in the system and weaken the wrapper keys, resulting in a lowering of the protection and robustness of the encryption method, allowing improper actors, criminals and hackers to exploit the weak key vulnerability to recompute the wrapper and file keys.

U.S. Pat. No. 7,787,623 shows an encryption method which proposes a key generating apparatus and method to improve upon a public-key cryptography using an algebraic surface, referred to as an algebraic surface cryptosystem. Public-key cryptography, or asymmetric cryptography, differs from symmetric key cryptography, where a public key, which can be known to others, is used to encrypt a message, and a private key, which remains secret, can decrypt the message. In symmetric key encryption, the key is not publicly shared. In this method, an algebraic surface defined as an algebraic surface having two-dimensional degrees of freedom in a set of solutions of simultaneous (algebraic) equations is defined by a finite algebraic field, K. X: f(x, y, z) are algebraic surfaces in the field, while X(x, y, z)=0 is a specific algebraic surface in field K. A plurality of algebraic curves represented by D₁: (uₓ(t), u_{y}(t), t), D₂: (vₓ(t), v_{y}(t), t) and Xₜ₀ represent divisors on the algebraic surface. Although this method utilizes algebraic surface to support the computation of encryption keys, this method uses finite fields and surfaces differing from the proposed method, which uses geometric manifolds. This method uses a plurality of polynomials representing algebraic curves, acting as divisors, to generate two keys, a public and private key, which differs from the proposed method which can use a polynomial or quadratic equation to solve for a unique point on the manifold surface to act as an unknown data source for a seed supplied to the key generating equation to generate a deterministic symmetric key. Furthermore, this method is based on public/private key pairing; therefore, the private keys must be stored in a CKMS to ensure proper pairing and to retain the ability to decrypt the information.

U.S. Pat. No. 8,311,215 is based upon and claims the benefit from prior U.S. Pat. No. 7,787,623 and extends the public-key cryptographic method to include an encryption apparatus, a decryption apparatus and a storage medium and (Ruiten, 2020). The encryption key generation method is a public/private key generation method based on an algebraic surface as described in U.S. Pat. No. 7,787,623. The encryption and decryption apparatus describe the implementation algebraic surface cryptography, to reduce the burden on the factorization process to realize the efficiency of the entire encryption or decryption process. This process is not a deterministic symmetric key encryption system and the keys must be retained for the duration of their required existence.

The invention is directed to a cryptographic system and corresponding method of encryption deployed in a battlespace to provide a secure cryptographic standard and service throughout and across a complicated system on a battlespace management system (BMS). The cryptographic system improves information security by implementing a unique key establishment protocol and process to compute a symmetric cryptographic key for the minimum duration of encrypting a data object or decrypting a protected data object, then destroying the key or otherwise requiring no storage method to retain the key. The key establishment protocol is a component of the system and a method to generate and regenerate a deterministic cryptographic key, whose process retains the highest entropy in key randomization and the full spectrum of the cryptographic key space without storage of, securing of, and maintaining a key store. Further, the invention describes how coefficient properties can be locally stored within the protected data object, ensuring the protected data object is secure and can be stored securely or transmitted without having to provide or manage cryptographic key material. The invention describes how the key establishment protocol component of the system and related methods are provided to the key generating service to recompute the symmetric key. Further, the invention describes a method to apply, associate, and attach access policies to the data object to regulate who or what is authorized to receive the cryptographic key. Access Policies contain the rules and procedures used to automate the provisioning of the cryptographic key to the requesting client to decrypt a protected data object. An aspect of this invention is that the cryptographic system is indifferent to the encryption method and can use existing encryption schemes, such as, but not limited to, the Advanced Encryption Standard (AES), Blowfish, Rivest Cipher, and Data Encryption Standard (DES).

The instant invention provides a system and method whereby the cryptographic key is not stored, rather, once used to encrypt a data object into a protected data object, the key is destroyed or rendered unavailable, thus the key is ephemeral or transient. The system provides a method where the key can be deterministically recomputed, to decrypt a protected data object; therefore, this method renders key storage unnecessary. An additional aspect of this cryptographic system is that it allows a data object to be protected and secured using blockchain smart contracts and attestation of ownership using Non-Fungible Tokens (NFT). This cryptographic system provides per-data object encryption and is indifferent to the method of transmittal and storage of the protected data object, allowing for local storage, network storage, cloud storage, storage on the blockchain, a decentralized file system, e.g., the Interplanetary File System (IPFS), or the like across multiple platforms and sub-systems.

### SUMMARY OF THE INVENTION

In view of the limitations of the prior art, an apparatus, device, engine, and methods, identified as a system, subsystems and protocols, components, objects services or elements of the subsystem, are disclosed to secure digital data objects and digital information using symmetric key cryptography.

The invention, according to the noted aspects, the figures, and the description is described in relation to an exemplary embodiment of the apparatus, system and method of operation of the system; however, the invention can also be realized not only as a system but also a computer enabled program, a method, or a computer readable storage medium with said program thereon, a device, a specialized computer or controller, and similar devices as a matter of course.

The invention according to the noted aspects and figures is comprised as a group of elements, objects, processes, and services to form components and methods, where components and methods function together idealized as a subsystem and protocol. In this inventions embodiment, subsystems function together across their functional boundary at interfaces using protocols to form a system.

The instance of this invention, the system can include but is not limited to a deterministic cryptographic key generation method, a key establishment protocol, access policies, an encryption method and decryption method, and a method to securely protect a data object as a protected data object.

This invention, according to the noted aspects identifies Data Objects (DOs), such as but not limited to, digital information, data files, data collections, data documents and electronic information in any format; unencrypted, encrypted, partially encrypted, encoded or not encoded.

An aspect of the present invention is the Protected Data Object (PDO). The PDO is itself a DO and the computing and information system can treat it as such; however, the PDO is created through a data packaging method, such as but not limited to a file archiver, and possesses additional information and metadata to adhere to the intent of this invention. The PDO includes, but is not limited to, the polynomial and quadratic equation coefficients (PQC), access policies in encrypted form (C_{Policy}), and DOs in encrypted form (C_{DO}). The primary benefits of the PDO are to ensure confidentiality, integrity and authenticity of the data, secured through encryption methods without the need for managing a cryptographic key(s). This method permits the PDO to be securely stored and, or transmitted without having to manage or securely transmit the key. A further aspect of the PDO is linking of the PDO to a block on a blockchain, and assigning a Non-Fungible Token (NFT) to the object for the attestation of authenticity to a person or organization.

The invention enables per-DO security, including individual data files, data collections, data documents, and the like, by protecting each individual DO through the use of encryption, each with a unique cryptographic key, to achieve a high level of security while operating in trusted, semi-trusted, and non-trusted/zero trust environments. In the exemplary embodiment, this is done in real-time, however, it can also be done in less than real-time without departing from the spirit of the invention.

The invention enables the generation of a deterministic cryptographic key as a component of a battlespace C2/C4 ISR system. The inventions protocol does not require storage of the key; therefore, the cryptographic key is ephemeral or transient for each DO generated and more difficult to intercept and reverse; the key thus generated by the method of the invention, through the cryptographic system or subsystem can be used to encrypt or decrypt the DO, then the key destroyed. This method can retain the entirety of the AES 256 cryptographic key space at affordable computational and storage costs, allowing the highest key entropy to remain in the system throughout its lifetime. The system is indifferent to the symmetric encryption algorithm type, e.g. the system is agnostic as to the exact method of encryption utilizing the key. The system is generating the key for use by the encryption methodology and then destroying the key by enabling a system for reconstituting the key.

The invention idealizes a key establishment protocol, which is a method to create and provision the cryptographic key to the requesting client. This differs from a key agreement protocol, which are generally found in asymmetric encryption methods, and is intended to prevent third parties from eavesdropping on data transmissions. This invention does not preclude the use of a key agreement protocol to pass information between the Client Subsystem to the Server Subsystem; however, the key establishment protocol includes a method that incorporates access policies to ensure the requesting client is authorized to receive the cryptographic key. If the policy is met, then key generating service provisions the cryptographic key to the client, otherwise, the key is not provided.

A still further aspect of the invention idealizes access policies as part of the key establishment protocol, which contain the rules and procedures used to automate the provisioning of the cryptographic key to the requesting client. Access policies, also described as policies and smart policies, can be user or process selected and are stored as an encrypted data block in the PDO as C_{Policy}. The C_{Policy} data block is provided to the key generating service, which decrypts the policy once the cryptographic key has been recomputed and executes the rule and procedure to follow. If the access policy has been met, then the key generating service provisions the cryptographic key (Kᵢ) to the requesting client. This method provides a robust way to regulate who or what is authorized to receive the cryptographic key.

An aspect of the present invention is the key establishment protocol, which can accommodate decentralized services, blockchain smart contracts protocols and Non-Fungible Tokens (NFTs) for a wider range of applicable functions and resulting products. Decentralized services typically utilize a permissionless structure that enables services distributed or delegated away from a central, authoritative location or group. Decentralize file systems, such as IPFS, is a protocol and peer-to-peer network for storing and sharing data in a distributed file system, anywhere and on any device or storage system. A “smart contract” is a computer protocol intended to digitally facilitate, verify, or enforce the negotiation or performance of a contract and can allow the performance of credible transactions without third parties. NFTs are cryptographic assets across the battlespace on a blockchain with unique identification codes and metadata that distinguish them from each other. The key establishment protocol enhances data object security in a distributed file system since the object can be protected through cryptographic means, while the key used to encrypt the data object does not require it to exist. Access policies can be built into smart contracts to function with the key establishment protocol to call the key generating service when the smart contract has been fulfilled. Ensuring authenticity of the file is paramount in a distributed file system; therefore, NFTs can be used to associate a cryptographic identification to the Protected Data Object to attest to the objects authenticity.

An aspect of the present invention is the provision of a cryptographic system having a secret 3-dimension mathematical geometric shape, referred to as a Manifold (M) herein, stored securely on a computing device, referred to as the Server Subsystem, as an integral part of the cryptographic key generating engine used in the subsystem and executing the method of the instant invention to provide a more secure encryption methodology.

According to the instant invention, the Manifold provides a compact topological surface, generally idealized as a manifold with a boundary, which is locally Euclidean. Manifold (M) can be described as, but is certainly not limited to, a sphere, torus, double torus, cross surface, a Klein Bottle, Riemannian, Kahler, a Calabi Yau, and similar shapes or algorithmic expressions. The complexity of the manifold is derived by the inputs into M, where a user or system function can select the manifold type and its properties to generate a unique manifold for the purpose of this invention. The manifold surfaces are transformed into a mesh-like surface, called surface facets, where each closed mesh surface represents a facet of the surface.

An aspect of the present invention are the manifolds facets. A facet can be represented as, but not exclusive of, a planar surface comprising of three or more vertexes. When all facets are assembled, they represent a course idealization of M. An aspect of the facet is a unique and secret Key Seed (KS), which is used as one component of the method to compute the cryptographic key. A unique KS is computed for each manifold facet and is securely store and held secret in the Manifold Table Object (MTO).

Yet another aspect of the present invention is the provision of one or more Manifold Table Object(s) (MTO), which stores, at a minimum, details of one or more manifolds, the manifold facets and the associated Key Seeds. The MTO is part of a set of data that stores the representation of the manifold, accessible by the key generating service, but generally not directly accessible by the client process. This separation enhances security by distributing the key component data, such that Kᵢ cannot be computed without the key generating service receiving the PQC from the PDO and the KS and facet from the MTO.

A further aspect of the present invention is the Polynomial or Quadratic Equation (PQ-Equation), wherein, the PQ-Equation can be for example, but is not limited to, a linear, a non-linear, an open or closed shape in one or more dimensions with the complexity of the PQ-Equation driven by the inputs into the PQ-Equation and wherein a user or system function can select the equation type and its properties to generate a unique PQ-Equation for the purposes of the instant invention. The PQ-Equation is mathematically computed into the 3-dimension space of the secret manifold, such that a minimum of one point on the PQ-Equation intersects perpendicularly to a facet of M in the key generating service to generate exclusive points on M.

An aspect of the present invention is the PQ-Equation coefficients (PQC(s)). PQC represents the coefficients which are provided to the key generating service to compute the idealized mathematical polynomial or quadratic equation into the 3-dimensional space with the manifold. The PQC is computed when the first computation of the cryptographic key is made and provided to the client to be stored within the Protected Data Object (PDO). The PQC is provided to the key generating service as one component of the method to recompute the key. PQCs are considered a type of Other Data, whose values need not be kept secret; however, they can be cryptographically secured. In the case of one type of PQ-Equation, as represented by a sphere, coefficients can include, for example, but are certainly not limited to the sphere's center point in 3-dimensional space and the sphere's radius. These coefficients allow the PQ-Equation generator to accurately plot the equation onto the secret manifold, identify the surface facet in the Manifold Table Object and compute the Surface Perpendicular Point (SPP).

From the perspective of improper actors, enemy EFW assets and decryption efforts, knowledge of the PQC only allows them to derive the fact that a polynomial or quadratic equation exists in 3-dimensional space. This knowledge does not reveal any detail of the manifold that would expose the facet and the SPP which is required to compute the cryptographic key. Furthermore, by including the PQC with the protected document, the key generating service cannot compute the cryptographic key without the coefficients, ensuring the security of the protected document and secrecy of its contents. The specific information regarding the manifold could be rotated and frequently resupplied to further enhance security.

An aspect of the invention is the Surface Perpendicular Point (SPP), which is a point on the manifold where the PQ-Equation is uniquely perpendicular to the manifold and can be recomputed by the key generating service. The PQ-Equation can intersect the manifold at an n-number of exclusive perpendicular locations; however, SPP is determined by the Polynomial or Quadratic Coefficients (PQC) when applied to the PQ-Equation and mapped onto the manifold.

A still further aspect of the present invention is a key generating service, which can be identified as a method, a process, or engine, which deterministically generates and regenerates a Symmetric Cryptographic Key (Kᵢ), of appropriate length for the encryption process being used within the encryption engine. The component computes the PQ-Equation into the manifolds 3-dimension space to mathematically identify the unique point SPP, representing the intersection of the PQ-Equation onto the manifold. The properties of the SPP, along with the properties of the PQ-Equation coefficients and the facet's key are combined through a hashing function to produce Kᵢ. The properties of each component key, K₁, K₂ and K₃ are made of sufficient unique data, when combined, can allow the computation of the maximum key space, Kᵢ, permitted by the encryption algorithm.

A still further aspect of the present invention is the cryptographic key (Kᵢ), also identified as key, which is used to encrypt the DO into a PDO and to decrypt the PDO into an accessible data object. Kᵢ is computed using two or more component keys combined through a process of concatenation, Exclusive-Oring or a combination of both. In the exemplary embodiment shown, three component keys; K₁, K₂ and K₃ are computed, then combined to create Kᵢ. K₁ is computed when the PQC is passed through a secure hash function. K₂ is computed when the secret plural bits of the SPP is passed through a secure hash function. K₃ is computed when the secret plural bits of the Key Seed are passed through a secure hash function. K₃ acts as a cryptographic salt to mitigate hash table style attacks by ensuring that any attacker who could use ultra-high performance computing systems to calculate the entirety of the K₂ component key space, still have no reasonable chance to re-compute Kᵢ for a PDO. When cryptographically combined, K₁, K₂ and K₃, the cryptographic key (Kᵢ) can be deterministically computed while maintaining the entropy and maximum key-space possible afforded by the encryption algorithm. To ensure secrecy of the key, the SPP is destroyed after computing Kᵢ, rendering recomputing Kᵢ impractical without full knowledge of the method and system components.

A further aspect of the instant invention is a robust protocol to manage the request to create, recreate and provision the cryptographic key, Kᵢ. The properties of the component keys are mathematically computed in a deterministic way, allowing Kᵢ to be recomputed as needed. Since Kᵢ can be recomputed, using the methods and protocols described, Kᵢ can be treated as an ephemeral key, rendering key storage methods unnecessary.

A further aspect of the instant invention allows each data object to be encrypted with a unique Kᵢ, permitting per-DO encryption without reusing the key. In addition to a unique per-DO Kᵢ, the protocol provides a method by which a single data object can be encrypted with a new cryptographic key each time the request to protect is made, e.g., save from unencrypted DO to a PDO. This permits a single DO, whose information and raw data contents can be updated over time to be protected uniquely from its previous instantiation.

A further aspect of the instant invention are access policies, also referred to as policies, which represent guidelines to a Policy Actions process, which implement procedures to achieve an intended outcome for returning the cryptographic key to the requesting client. Access policies are actions, such as, but certainly not limited to, ‘Open by Smart Contract’, ‘Do Not Open Before Date’, ‘Open by Phone Number’, ‘Open by Devices’, and the like and enhance data security and making sure the data remains secure ahead of command processes and information flows within the C2/C4 ISR subsystems. The access policies can be selectable by a user, process or by other methods. Access policies are protected as an encrypted data block inside the PDO to ensure policy integrity. When a PDO is requested for access as a DO, the polynomial and quadratic coefficients, along with the encrypted policy data block, representing the access policy, are provided to the key generating service. Once Kᵢ has been computed, but before it is returned to the client to decrypt the PDO, the Policy Actions process decrypts the encrypted policy data block and executes the policy action.

In the exemplary embodiment, the ‘Do Not Open Before Date’ access policy can protect the PDO from being decrypted and viewed, by ensuring the requesting client does not receive Kᵢ before the date as described in the policy. This policy action provides, but is certainly not limited to, mission specific data or target information or similarly date and time specific data that can be accessed by the proper assets at the proper time and this policy setting would ensure that and further prevent unauthorized access Thus as further layer of security, the policy element prevents a corrupt individual or mismanaged or compromised document storage system leaking mission data, preventing an adversary from reading the information and further providing for additional policies—such as an alert—attached to such attempts at access. Regardless of whether notification is tripped, by applying an access policy which prevents the protected data object from being viewed in its unprotected format ahead of a date, the mission window and data would be rendered unreadable until a proper release time/date request could be submitted and the PDO's could be viewed.

In the exemplary embodiment, the ‘Open by Phone Number’ access policy can be used as an add additional layer of security when a PDO is transmitted or otherwise provided to another party. An example use of this policy action provides, but is certainly not limited to, a method by which the receiving party can receive a digital token by Short Messaging Service (SMS) or other secure messaging method to validate that the receiving party. The token would be provided by the receiving party to the Policy Actions process before release of Kᵢ.

In the exemplary embodiment, the ‘Open by Devices’ access policy can be used as an additional layer of security to restrict providing Kᵢ to an approved client or process. This policy action provides, but certainly is not limited to, the release of Kᵢ for a PDO to specific device(s) or process. An example of the use of this policy action would be to protect queries and computational results used on large sets of data, or big data. Exemplary embodiments employing the system of the invention, can include, but are certainly not limited to searching, search results, data generated by intelligence gathering, government entities, researchers, etc., or other entities that desire their query criteria and the findings to remain confidential when working with public, open-source and commercial data. This method can restrict providing Kᵢ to specific devices and processes, such that only those devices and processes authorized to read the query to run against the data and read the results from the query can decrypt the protected data object.

Yet a further aspect of the present invention is the client subsystem, which is provided to users or computer processes to access a PDO or to cryptographically secure a DO into a PDO. The subsystem can include but is not limited to a User Experience/User Interface (UX/UI), graphical interface or a process which interfaces with an Operating System (OS) Application Program Interfaces (API) to support OS processes necessary to access, open, load, save, close, and the like a file object to make the PDO accessible or loading an unprotected DO and securing the DO with this patent's method.

An aspect of the invention is to provide a high level of data and information security through the use of cryptography and encryption on a per-data object basis, which is efficient and cost effective as used. The use of encryption on a per-data object basis incurs computation costs; however, most organizations do not need to access all documents on a daily basis, therefore the cost to encrypt a DO into a PDO and decrypt the PDO is significantly lower and spread over time over the entire breath of all files. This method eliminates a need to acquire and maintain a Cryptographic Key Management System (CKMS), or key store, while protecting the entirety of the organizations data objects. In organizations requiring high-security, such as, but certainly not limited to, large and multi-national corporation, defense, government, intelligence, medical and banking institutions, the cryptographic system can be employed as a secure system inside the boundary of the secure network environment. Other organizations, such as but not limited to, state and local governments, colleges and universities, public and private schools and school systems, medical offices, Small and Medium Business' (SMB's) can employ and utilize the system in a closed, semi-accessible network, cloud or other distributed environments. The cryptographic system is indifferent to the existence of a network and can be employed on a computing device, a computing dongle, a smart card, a cloud or hybrid-cloud environment, decentralized network, a traditional network or a hybrid of these types.

The invention includes a cryptographic system, an encryption and decryption method, a networked system for securing a Data Object (DO) as a Protected Data Object (PDO), an at least one key establishment protocol operating a cryptographic system.

The invention further includes a system for securing a Data Object (DO) as a Protected Data Object (PDO) by encrypting the DO with an asymmetric ephemeral cryptographic key (Kᵢ) having precomputable stored components to recalculate Kᵢ during decryption, the system having an at least one server, an at least one client device; an at least one network or data transport connecting electronically the server and client device. With an at least one encryption/decryption engine residing on the at least one server, the at least one client device and the at least one network or data transport, the encryption/decryption engine including an at least one digital manifold, an at least one quadratic surface, a unique surface perpendicular point (SPP) solution through the interaction of the at least one digital manifold and the at least one quadratic surface to generate an at least one set of identifiers including an at least one polynomial/quadratic equation coefficient (PQC) and an initial key seed value to solve for the unique SPP. Where the solution of the SPP and the at least one set of identifiers in conjunction with the at least one manifold and the quadratic surface results in a unique solution for Kᵢ which encrypts the at least one DO to become the at least one PDO and where Kᵢ is rendered unavailable after the encryption process.

The at least one set of identifiers can be stored securely to be used to deterministically recompute the Kᵢ on demand for decryption. The system can provide that after the encryption is completed an at least one set of identifiers for Kᵢ can be stored securely apart from one another and accessed to deterministically recompute Kᵢ on demand for decryption. The system further provides a PDO that includes at least one set of policies stored with the PDO for decryption. Wherein the system can further provide that the at least one set of policies is checked prior to decryption. The at least one set of policies can refer to a block chain element. The at least one set of identifiers can include component keys K₁ and K₂, derived respectively from at least one of the PQC, the SPP, and the Key Seed, and said component keys are stored as at least one of the at least one set of identifiers. The quadratic surface can be one of a circle, ellipse, parabola, or hyperbola if in two dimensions or a sphere, ellipsoid or other surface if in three dimensions. The quadratic surface is a sphere having radius and a center point defined by a radius value and values for a center in the x,y,z coordinates system. The manifold can be at least one of a sphere, a torus, or a Klein bottle.

The invention includes a method of encryption including the steps of presenting a data object; requesting encryption of the data object; requesting and selecting a three-dimensional manifold and thereby an at least one manifold table object representing the manifold surface, the manifold surface having one or more facets thereon; generating randomly an initial key seed as a value then using that initial key seed value to determine an at least one facet on the manifold surface from the at least one manifold table object; locating a facet location on the three-dimensional manifold based on the intersection of the polynomial or quadratic equation with the manifold surface; generating a polynomial or quadratic equation with an at least one polynomial or quadratic equation coefficient(s); locating a center of the generated polynomial or quadratic equation based on the at least one polynomial or quadratic equation coefficient(s); solving for an at least one surface intersection point whereby the at least one polynomial or quadratic equation is solved at a point on the at least one facet location such that the surface point is calculated at an interface of the at least one polynomial or quadratic equation and the manifold object at a predefined solution set for the surface intersection point; generating using the surface intersection point solution in combination with the key seed and the polynomial quadratic coefficients an encryption key; storing at least the polynomial or quadratic coefficient, the key seed, and the surface intersection point; encrypting the data object using the generated key to form a protected data object; rendering the key unavailable and unretrievable as a unitary key without the at least the polynomial or quadratic coefficient, the key seed, and the surface intersection point; and returning the protected data object without a full key on or in the protected data object.

The encrypting the data object step can further include a method step of passing the at least the polynomial or quadratic coefficient, the key seed, and the surface intersection point through a hash function. The surface intersection point used in the method can be one of a tangent point or perpendicular point between the surface and the manifold. The surface intersection point can be a perpendicular point.

The invention further includes an encryption component as a portion of a controller or computer or program stored on a computing device, the encryption engine having a secure storage means to protect confidentiality of the information held in a data object, with a user experience (ux)/user interface (ui). An asymmetric encryption key requestor is provided with a manifold generator, generating a manifold in Euclidian space having facets and a key seed generator, generating randomly an initial key seed as a value then using that initial key seed value to determine an at least one facet on the manifold surface from an at least one manifold table object. A surface generator using an at least one polynomial or quadratic equation is provided, solving the at least one polynomial or quadratic equation for the unique surface point on the determined at least one facet with an encryption engine adapted to generate an ephemeral, short lived, asymmetric encryption key (Kᵢ) using an at least one value from an at least one key seed, a unique surface intersection point, and an at least one polynomial or quadratic coefficient.

The encryption component further includes a means to add an at least one access policy to the protected data object. The encryption component can also further include a decryption engine adapted to check the at least one access policies added to the protected data object, reconstituting the ephemeral, short lived, asymmetric encryption key (Kᵢ) using at least one value from at least one key seed, a unique surface intersection point, and an at least one polynomial or quadratic coefficient and decrypting the at least one protected data object to render the at least one data object. The encryption component can still further include a PDO packager.

The invention includes a system for securing a Data Object (DO) as a Protected Data Object (PDO) by encrypting the DO with an asymmetric encryption key (Kᵢ) such that it is highly resistant to reverse analysis, the system having a means for storing on a secure storage to protect confidentiality of the information held in a data object with an encryption engine performing a set of instructions so that it derives an encryption key (Kᵢ), generates a set of deterministic values to recreate Kᵢ, manages Kᵢ as a short-lived, ephemeral key destroyed after encryption, encrypts at least one data object called from the secure storage to render an at least one protected data object and destroys the Kᵢ and stores the set of deterministic values to recreate Kᵢ. The system including a secure means to add an at least one access policy to the protected data object, a decryption engine performing a set of instructions so that it checks the at least one access policies added to the protected data object to proceed, retrieves the set of deterministic values for Kᵢ when prompted by a secure call, derives the encryption key (Kᵢ) from the deterministic values as a short-lived, ephemeral key, decrypts the at least one protected data object to render the at least one data object, and a means to store or display the at least one data object.

The system can further includes a shim/shimming process between a client program and the operating system function call to integrate the encryption and decryption process into a client program process flow. The system using the method steps of encrypting can further comprise providing a client encryption and decryption component that can request a unique key from a remote key generating server or service on a network. The system can further provide a client subsystem that allows a user or computing process to access a data object or protected data object. The system can further receive one or more instructions from a user interface to enable a user or computing process to directly select a data object or protected data object from file storage. The system can include reading metadata, stored as mathematical coefficients, and placed inside the protected data object by the method to assist the server to recompute Kᵢ. The network or communication link can utilize any method which permits information to flow from the client subsystem to the server subsystem and/or from the server subsystem to the client subsystem.

The invention also includes a system for creating a pseudo-random, symmetric encryption key for use in a computer network system the system rendering a manifold in Euclidean space, generating surface facets that represent the manifold in a mapping structure, assigning key seeds to the surface facets which exist in secure table entry value, computing a unique surface perpendicular point value, solving a polynomial and/or quadratic equation solutions for the intersection with the unique surface perpendicular point, generating a combination of key components from at least one of the key seeds, the unique surface perpendicular point, and the polynomial and/or quadratic equations, combining the combination of key components into an at least one asymmetric key; and using the asymmetric key to encrypt an at least one unprotected data object into an at least one protected data object. The system can further recreate the asymmetric key to decrypt the protected data object into the unprotected data object. The system can also include a component providing policies for the return of the key to a client subsystem. The policies can be stored in the protected data object as an encrypted data block and can only be decrypted by a server or service performing the step of generating the encryption key by the system.

The invention further includes a system for securing a Data Object (DO) as a Protected Data Object (PDO) in a battlespace management system (BMS) or as a subsystem of the BMS or as a component of one or more elements being managed by the BMS by encrypting the DO with an asymmetric ephemeral cryptographic key (Kᵢ) having precomputable stored components to recalculate Kᵢ during decryption, the system having an at least one server with an at least one client device and an at least one communications network or data transport connecting electronically the server and client device, an at least one encryption/decryption engine residing on at least one of the at least one server, the at least one client device and the network. The encryption/decryption engine including an at least one digital manifold an at least one quadratic surface, a unique surface perpendicular point (SPP) solution through the interaction of the at least one digital manifold and the at least one quadratic surface to generate an at least one set of identifiers including an at least one polynomial/quadratic equation coefficient (PQC) and an initial key seed value to solve for the unique SPP, wherein the solution of the SPP and the at least one set of identifiers in conjunction with the at least one manifold and the quadratic surface results in a unique solution for Kᵢ which encrypts the at least one DO to become the at least one PDO and whereby Kᵢ is rendered unavailable after the encryption process and the at least one set of identifiers is stored securely to be used to deterministically recompute the Kᵢ on demand for decryption.

The system providing after the encryption is completed the at least one set of identifiers for Kᵢ can be stored securely apart from one another and accessed to deterministically recompute Kᵢ on demand for decryption. The PDO can include at least one set of policies stored with the PDO for decryption. The s at least one set of policies can be checked prior to decryption. The at least one set of policies can refer to a block chain element. The at least one set of identifiers can include component keys Kᵢ, K₂, and K₃ derived respectively from the at least one PQC, the SPP, and the at least one initial key seed, and said component keys are stored as at least one of the at least one set of identifiers.

In the system the quadratic surface can be one of a circle, ellipse, parabola, or hyperbola if in two dimensions or one of a sphere, ellipsoid or other surface if in three dimensions. The quadratic can be a sphere having radius and a center point defined by radius value and a set of values for a center. The manifold can be at least one of a sphere, a torus, a Klein bottle, or other surface manifold.

The apparatus of the invention includes a circuit board having an at least one ASIC thereon and having a communications bus or coupled to a communications bus, wherein the ASIC is configured to communicate with and receive instructions from an operating system and provide a key provisioning system to a cryptographic system communicating with the operating system in a battlespace management system (BMS) or as a subsystem of the BMS or as a component of one or more elements being managed by the BMS, including means for transmitting a data object for encryption or a protected data object for decryption to the circuit board through the communications bus, an at least one encryption/decryption engine, an at least one transient cryptographic key generator including a three-dimensional manifold engine and an at least one manifold table stored on the ASIC and calculating an at least one transient key sub-component an thereby further calculating a transient cryptographic key and communicating these values and the calculated transient encryption key with/to the encryption/decryption engine, wherein the circuit board ASIC is configured to communicate with the operating system via an encryption call through the transmission means to provide the transient cryptographic key to the encryption engine to encrypt the data object or via a decryption call through the transmission means for a previously encrypted protected data object and calculate with the three-dimensional manifold engine a transient encryption key and key sub-components for the encryption/decryption engine to process the data object into an encrypted protected data object or to decrypt the previously encrypted protected data object using the transient key and key sub-components, then rendering the transient key unavailable.

An electronic device having a processor circuit configured to run an operating system or operate within an operating system and communicate via a communications bus, the processor circuit further configured to communicate with and receive instructions from the operating system and provide a key provisioning system to a cryptographic system communicating with the operating system, the device including means for transmitting a data object for encryption or a protected data object for decryption to the circuit board through the communications bus, an encryption/decryption engine, a circuit configured to provision a transient cryptographic key by generating an at least one manifold table having manifold data identifying the manifold, calculating an at least one transient key sub-component, and utilizing the at least one transient key subcomponent to generate a solution from the manifold table data and thereby further calculating a transient cryptographic key and communicating these values and the calculated transient encryption key to the encryption/decryption engine, wherein the processor circuit is configured to communicate with the operating system via an encryption call through the transmission means to provide the transient cryptographic key to the encryption engine to encrypt a data object or via a decryption call through the transmission means for a previously encrypted protected data object and calculate with the manifold the transient encryption key and at least one key sub-components for the encryption/decryption engine to process the data object into an encrypted protected data object or to decrypt the previously encrypted protected data object using the transient key and at least one key sub-components, then rendering the transient key unavailable.

The processor generating the manifold can be further configured to process a request and select a specific three dimensional manifold from several such manifolds stored within the processor as the data in the at least one manifold table and thereby an at least one manifold table object representing a manifold surface for the manifold, the manifold surface having one or more facets thereon. The at least one manifold table can be related to the manifold and stored on the processor circuit and a random number generator generating randomly an initial key seed as a value can be provided and then uses the initial key seed value to determine an at least one facet on the manifold surface from the at least one manifold table object.

The processor circuit can be further configured to calculate the transient cryptographic key using the requested specific three dimensional manifold and the initial key seed and the initial key seed value to locate a facet location on the three dimensional manifold. The processor circuit can be further configured to calculate a polynomial or quadratic equation with an at least one polynomial or quadratic equation coefficient data block. The processor circuit can be further configured to locate a center of the calculated polynomial or quadratic equation based on the at least one polynomial or quadratic equation coefficient data block. The processor circuit can be further configured to solve for an at least one surface intersection point whereby the at least one polynomial or quadratic equation and the surface represented by the at least one polynomial or quadratic equation is solved at a selected facet location such that the at least one surface intersection point is calculated at an interface of the at least one polynomial or quadratic equation and the manifold object providing a defined solution set for the surface intersection point. The processor circuit can be further configured to provision the surface intersection point solution set in combination with the key seed and the polynomial quadratic coefficients to generate the transient encryption key

The encryption/decryption engine can encrypt the data object into a protected data object or decrypts the previously encrypted protected data object into a data object using the generated transient encryption key. The encryption/decryption can be further configured to render the key unavailable and unretrievable as a unitary key without an at least on key identifier. The at least one key identifier can be an at least one of the polynomial or quadratic coefficient data block, the key seed, and the surface intersection point. The at least one key identifier can also be the polynomial or quadratic coefficient data block.

The encryption/decryption engine can be adapted to configured to render the key unavailable and unretrievable as a unitary key and can be further configured so that when it provisions the transient key it passes the at least one of the polynomial or quadratic coefficient, the key seed, and the surface intersection point through a hash function as part of the process of rendering the key unavailable. The surface intersection point can be one of a tangent point or perpendicular point between the surface and the manifold. The surface intersection point can be a perpendicular intersection solution for a selected point on the facet surface on the manifold relative to polynomial or quadratic equation.

The method of the invention includes a method of encryption within a battlespace management system (BMS) comprising presenting a data object; requesting encryption of the data object; requesting and selecting a three dimensional manifold and thereby an at least one manifold table object representing the manifold surface, the manifold surface having one or more facets thereon; generating randomly an initial key seed as a value then using that initial key seed value to determine an at least one facet on the manifold surface from the at least one manifold table object; locating a facet location on the three dimensional manifold based on the initial at least one facet; generating a polynomial or quadratic equation with an at least one polynomial or quadratic equation coefficient(s); locating a center of the generated polynomial or quadratic equation based on the at least one polynomial or quadratic equation coefficient(s); solving for an at least one surface intersection point whereby the at least one polynomial or quadratic equation is solved at a point on the at least one facet location such that the surface point is calculated at an interface of the at least one polynomial or quadratic equation and the manifold object at a predefined solution set for the surface intersection point; generating using the surface intersection point solution in combination with the key seed and the polynomial quadratic coefficients an encryption key; storing at least the polynomial or quadratic coefficient, the key seed, and the surface intersection point; encrypting the data object using the generated key to form a protected data object; rendering the key unavailable and unretrievable as a unitary key without the at least the polynomial or quadratic coefficient, the key seed, and the surface intersection point; and returning the protected data object without a full key on or in the protected data object.

The data object step can further include a method step of passing the at least the polynomial or quadratic coefficient, the key seed, and the surface intersection point through a hash function. The surface intersection point can be one of a tangent point or perpendicular point between the surface and the manifold. The surface intersection point can be a perpendicular point.

The apparatus of the invention includes an encryption component as a portion of a controller or computer or program stored on a computing device in a battlespace platform, the encryption engine including a secure storage means to protect confidentiality of the information held in a data object, a ux/ui, an asymmetric encryption key requestor, a manifold generator, generating a manifold in Euclidian space having facets, a key seed generator, generating randomly an initial key seed as a value then using that initial key seed value to determine an at least one facet on the manifold surface from an at least one manifold table object, a surface generator using an at least one polynomial or quadratic equation, solving the at least one polynomial or quadratic equation for the unique surface point on the determined at least one facet, and an encryption engine adapted to generate an ephemeral, short lived, asymmetric encryption key (Kᵢ) using at least value from at least of an at least one key seed, a unique surface intersection point, and an at least one polynomial or quadratic coefficient.

The encryption component further including a means to add an at least one access policies to the protected data object. The encryption component further comprises a decryption engine adapted to check the at least one access policies added to the protected data object, reconstituting the ephemeral, short lived, asymmetric encryption key (Kᵢ) using at least value from at least of an at least one key seed, a unique surface intersection point, and an at least one polynomial or quadratic coefficient and decrypting the at least one protected data object to render the at least one data object. The encryption component can further include a PDO packager.

The system of the invention includes a system for securing a Data Object (DO) as a Protected Data Object (PDO) by encrypting the DO with an asymmetric encryption key (Kᵢ) such that it is highly resistant to reverse analysis as a subsystem in a battlespace management system (BMS), comprising: a means for storing on a secure storage to protect confidentiality of the information held in a data object; an encryption engine performing a set of instructions so that it derives an encryption key (Kᵢ), generates a set of deterministic values to recreate Kᵢ, manages Kᵢ as a short-lived, ephemeral key destroyed after encryption, encrypts at least one data object called from the secure storage to render an at least one protected data object and destroys the Kᵢ and stores the set of deterministic values to recreate Kᵢ; a secure means to add an at least one access policy to the protected data object; an decryption engine performing a set of instructions so that it checks the at least one access policies added to the protected data object to proceed, retrieves the set of deterministic values for Kᵢ when prompted by a secure call, derives the encryption key (Kᵢ) from the deterministic values as a short-lived, ephemeral key, decrypts the at least one protected data object to render the at least one data object; and a means to store or display the at least one data object.

The system further including a means for providing a shim/shimming process between a client program and the operating system function call to integrate the encryption and decryption process into a client program process flow. The method steps of encrypting further comprises providing a client encryption and decryption component that can request a unique key from a remote key generating server or service on a network. The system can also further comprise providing a client subsystem that allows a user or computing process to access a data object or protected data object. The system further comprising receiving one or more instructions from a user interface to enable a user or computing process to directly select a data object or protected data object from file storage. The system can further include a means for reading metadata, stored as mathematical coefficients and placed inside the protected data object by the method to assist the server to recompute Kᵢ. The system can further include network or communication link can be any method which permits information to flow from the client subsystem to the server subsystem and from the server subsystem to the client subsystem.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings, where the similar reference numerals refer to similar features.

FIGS. 1A-1B are a views that illustrates the use of the cryptographic system incorporated in an integrated battlespace management system according to an exemplary embodiment.

FIG. 1C is a schematic showing the overall architecture of a cryptographic system according to an exemplary embodiment.

FIG. 2 is a view that illustrates the data transport, client process and server service connections according to the embodiment of FIG. 1C.

FIG. 3 is a view which illustrates data containers, which are the unprotected and protected data object according to the embodiment of FIG. 1C.

FIG. 4 is a view which illustrates the PDO access policy integrated into a blockchain smart contract with NFT.

FIG. 5 is a view showing the components of an exemplary embodiment of the client subsystem.

FIG. 6 is a process flow chart view showing a client shimming process.

FIG. 7 is a view showing an exemplary embodiment of the client encryption component.

FIG. 8 is a process flow chart view showing an exemplary embodiment of the client encryption process.

FIG. 9 is a view showing an exemplary embodiment of the client decryption component.

FIG. 10 is a process flow chart showing an exemplary embodiment of the client decryption process.

FIG. 11 is a view showing the components of an exemplary embodiment of the server subsystem.

FIG. 12 is a view showing an exemplary embodiment of the Kᵢ computing component according to the embodiment of FIG. 1.

FIG. 13 is a process flow chart showing an exemplary embodiment of the Kᵢ computing process when PQC and C_{Policy} are null according to the embodiment of FIG. 12.

FIG. 14 is a process flow chart showing an exemplary embodiment of the Kᵢ computing process for PQC and C_{Policy} is not null according to the embodiment of FIG. 12.

FIG. 15 is a 3-D graphical illustration showing an exemplary embodiment of a PQ-Equation and PQC mapped to the manifold and the facet.

FIG. 16 is a view showing an exemplary embodiment of the manifold object generator component.

FIG. 17 is a process flow chart showing an exemplary embodiment of the manifold object generator process of FIG. 16.

FIG. 18 is a view showing an exemplary embodiment of the KS pseudo-random number generating component.

FIG. 19 is a process flow chart for an exemplary embodiment of the KS pseudo-random number generating process of FIG. 18.

### DETAILED DESCRIPTION OF THE EXEMPLARY EMBODIMENTS OF THE INSTANT INVENTION

Exemplary embodiments according to the present invention will now be described with reference to the accompanying drawings.

The danger in allowing data to exist without protection is myriad. In the most direct and obvious examples, criminals can gather pieces of data and use it to identify personally identifiable information (PII) or they may want to blackmail a company by threatening to release private data or hold them hostage via ransomware attacks. But in terms of military and government operations, the stakes are much higher. Battlespace threats are unique, high stakes and replete with cutting edge technology in both the aggressor and the defender roles. Defense starts with securing the data. Encryption is key to the art of data protection.

Encryption methodologies have been in society since 600 BC, protecting some of the most critical information, from military planning to crop results. Encryption is applied to secure files, in file level encryption, or data, in object level encryption, or through other mechanisms and in other categories. At its most basic, encryption is a method by which data is converted into a code that hides the data's true meaning and content. Though the concept might seem easy to grasp, in reality, the process of encryption is, in fact, a rather complex one to execute. The complexity within the elements of any encryption adds to the level of protection. Moreover, the less complex the encryption methodology the more likely it is to be overcome.

Today, encryption is conducted by and on a wide variety of devices and networks we access regularly to protect our communication and applied to a wide range of items. The degree of this encryption and the strength of the protection is varied by the need for speed in communication and ease of use as well as the limitations of computational power.

In an effort to provide a more robust encryption methodology and improve the ease of use of encryption suitable for use in a wide variety of environments the instant invention provides a unique methodology utilizing, in at least part but certainly not being limited to,
At least one key establishment protocol
At least one n-dimensional manifold
At least one polynomial or quadratic equation or surface
At least one cryptographic key generator
One or more embedded key access management policies
At least one encryption schema

The cryptographic system improves information security by implementing a unique key establishment protocol and process to generate a symmetric cryptographic key for a maximum duration of encrypting or decrypting a data object, then destroying the key or otherwise requiring no storage method to retain the key. The invention locally stores coefficient properties and access policy data blocks within the protected data object, which is used to generate the cryptographic key (Kᵢ) without the need to store Kᵢ. The key establishment protocol defines the rules, syntax, and semantics of the data blocks transmitted between the Client Subsystem and server key generating service, used to compute or generate and recomputed or regenerate the symmetric key. The Policy Actions process provides a method to apply access policies to the data object, which informs the Server Subsystem under what conditions the cryptographic key can be provided to the requesting client.

The methods, apparatus, and systems disclosed are unique in that they wraps multiple layers of mathematical complexity to/into the encryption methodology as well as multiple discrete key components transmitted in part as separate components providing a more robust solution without decreasing the entropy and randomization within the system, as the number of permutations for unique solutions remains extraordinarily high with extremely low chance of repetition. This methodology can be incorporated as part of an encryption engine that is integrated or embedded into devices at the hardware, operating system and application layer as a device application, cloud-based applications, blockchain applications, physical storage devices, operating system kernels, and the like.

The instant invention utilizes symmetric key encryption methods. In the exemplary embodiment shown, symmetric cryptographic is utilized as a non-limiting example for this exemplary embodiment. The symmetric cryptographic key (Kᵢ) in each embodiment is computed from component keys (K₁ . . . Kₙ) and are combined to form Kᵢ, using, but not certainly not limited to, at least one the following or a combination of the methods of equations 1 and/or 2:

### Concatenating Two or More Keys

$${K}_{i} = {K}_{1} \vert \vert {K}_{2} \vert \vert {K}_{3} \vert \vert … \vert \vert {K}_{n} \qquad ( 1 )$$

Exclusive-Oring one or more symmetric keys and other items of data.

$${K}_{i} = {K}_{1} ⊕ {K}_{2} ⊕ {K}_{3} ⊕ … ⊕ {K}_{n} ⊕ {D}_{1} ⊕ … ⊕ {D}_{n} \qquad ( 2 )$$

Component key (Kᵢ) is mathematically computed through a secure hash algorithm, Expression 4, using a concatenation of other data, defined in this embodiment as PQC, illustrated in Expression (3).

$$PCQ = i \vert \vert j \vert \vert k \vert \vert r \vert \vert … \vert \vert {D}_{n} \qquad ( 3 )$$

$${K}_{1} = PQC \to f ( hash ) \qquad ( 4 )$$

Component key (K₂) is mathematically computed through a secure hash algorithm, illustrated in Expression 6, using a concatenation of other data, defined in this embodiment as SPP, illustrated in Expression (5) and defined herein below.

$$SPP = m \vert \vert n \vert \vert o \vert \vert … \vert \vert {D}_{n} \qquad ( 5 )$$

$${K}_{2} = SPP \to f ( hash ) \qquad ( 6 )$$

The Key Seed (KS) concatenates a Pseudo Random Number Generator (PRNG), Manual Object Features Input (MOFI), Manual Random Number Generator (MRNG) and other data, defined in this embodiment, illustrated in Expression (7).

$$KS = f ( PRNG ) \vert \vert MOFI \vert \vert MRNG \vert \vert … \vert \vert {D}_{n} \qquad ( 7 )$$

Component key (K₃) is mathematically computed by passing the KS through a secure hash algorithm, illustrated in Expression (8).

$${K}_{3} = f ( hash ( KS ) ) \qquad ( 8 )$$

In particular, as represented by, but not limited to, Expressions (9), (10), and (11), a manifold is defined as topological space that locally resembles Euclidean space, taking a geometric object [symbol] and fitting into [symbol] , n>k.
M can be, but is not limited to, a sphere

$$0 = \begin{matrix}( {x}^{2} + {y}^{2} + {z}^{2} - 1 ) & ( z > 0 and z < 0 )\end{matrix} \qquad ( 9 )$$

M can also, for example, be but is not limited to being represented as a torus

$${a}^{2} = {( c - √ ( {x}^{2} + {y}^{2} ) )}^{2} + {z}^{2} \qquad ( 10 )$$

$$x = ( c + a cos v ) cos u$$

$$y = ( c + a cos v ) sin u$$

$$z = a sin v$$

M can additionally be but is not limited to being represented as a Klein Bottle

$$0 = ( {x}^{2} + {y}^{2} + {z}^{2} + 2 y - 1 ) [ {( {x}^{2} + {y}^{2} + {z}^{2} - 2 y - 1 )}^{2} - 8 {z}^{2} ] + 16 xz ( {x}^{2} + {y}^{2} + {z}^{2} - 2 y - 1 ) \qquad ( 11 )$$

$$x = cos u [ cos ( u / 2 ) ( √ 2 + cos v ) + sin ( u / 2 ) sin v cos v ]$$

$$y = sin u [ cos ( u / 2 ) ( √ 2 + cos v ) + sin ( u / 2 ) sin v cos v ]$$

$$z = - sin ( u / 2 ) ( √ 2 + cos v ) + cos ( u / 2 ) sin v cos v ]$$

In each embodiment, the manifold is processed into the projective Euclidean space. Finite element analysis and surface mesh generation algorithms transform the [symbol] geometric manifold M into surface facets, illustrated in Expression (12).

$$( {x}_{1} , {y}_{1} , {z}_{1} ) \to ( {x}_{2} , {y}_{2} , {z}_{2} ) \to … \to ( {x}_{n} , {y}_{n} , {z}_{n} ) \qquad ( 12 )$$

A polynomial is defined as an expression comprising of indeterminates and coefficients, that involves the operations of addition, subtraction, multiplication, and non-negative integer exponentiation of variables. The polynomial is processed into the projective Euclidean space, illustrated in Expression (13).

$${a}_{n} {x}^{n} + {a}_{n - 1} {x}^{n - 1} + … + {a}_{2} {x}^{2} + {a}_{1} x + {a}_{0} \qquad ( 13 )$$

A quadratic equation is an algebraic expression of the second degree in x. In each embodiment, the quadratic equation can represent a circle, ellipse, parabola or hyperbola in two variables. The quadratic is processed into the projective Euclidean space, illustrated in Expression (14).

$${ax}^{2} + bx + c = 0 \qquad ( 14 )$$

A quadratic surface is an algebraic expression of the third degree. In each embodiment, the quadratic surface can represent a sphere, ellipsoid, or other algebraic topology in three variables. The quadratic surface is processed into the projective Euclidean space, illustrated in Expression (15).

$$\begin{matrix}( {x}^{2} + {y}^{2} + {z}^{2} - 1 ) = 0 & ( z > 0 and z < 0 )\end{matrix} \qquad ( 15 )$$

In the exemplary embodiment, a surface manifold, M, is processed into a surface mesh and decomposed into facets, as represented by Expression (12). These facets are stored in a database and are selected randomly to participate in the generation of key (Kᵢ) for an encryption request. For decryption, Kᵢ is computed by processing the polynomial or quadratic equation or surface into the Euclidean space, Expressions (14) or (15), computing a point or set of points on M, where the polynomial or quadratic equation or surface interact with M. In this embodiment, a perpendicular interaction at the intersection between M and the polynomial or quadratic equation or surface is used as a valid point or set of solutions; however, other interactions, such as but not limited to a tangent can be used to identify a unique interaction with M.

Although a set of perpendicular points exist within the solution set, one point is calculated and uniquely represents the Surface Perpendicular Point (SPP). There are several ways to solve for SPP, one method uses vector math. This embodiment, Kᵢ cannot be computed without bringing together the Protected Data Objects (PDO) Polynomial/Quadratic Equation Coefficients (PQC) into the model manifold M to compute the SPP as represented in Expression (2).

In this embodiment, standard approved encryption algorithms and computing libraries are used to transform a Plaintext (P) into Ciphertext (C) and from ciphertext back into plaintext. It is to be understood by those of ordinary skill in the art that as new encryption algorithms and computing libraries are developed, these would be embraced and incorporated in the instant invention. The encryption and decryption processes of the exemplary embodiment used as a non-limiting example of the instant invention are represented by Expressions (16) and (17).

$$Plaintext to Ciphertext ( P \to C )$$

$$C = E ( {K}_{i} , P ) \qquad ( 16 )$$

$$Ciphertext to Plaintext ( C \to P )$$

$$P = D ( {K}_{i} , C ) \qquad ( 17 )$$

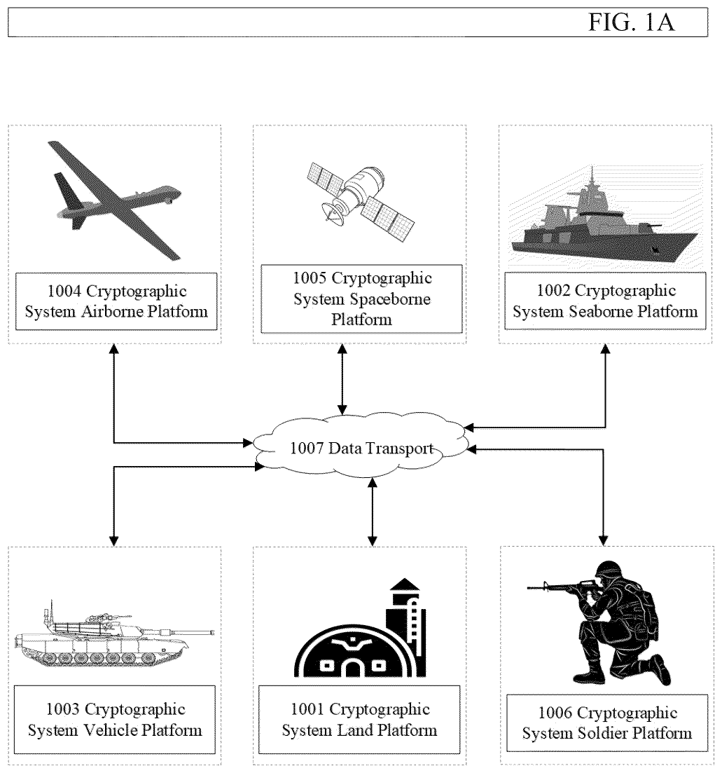

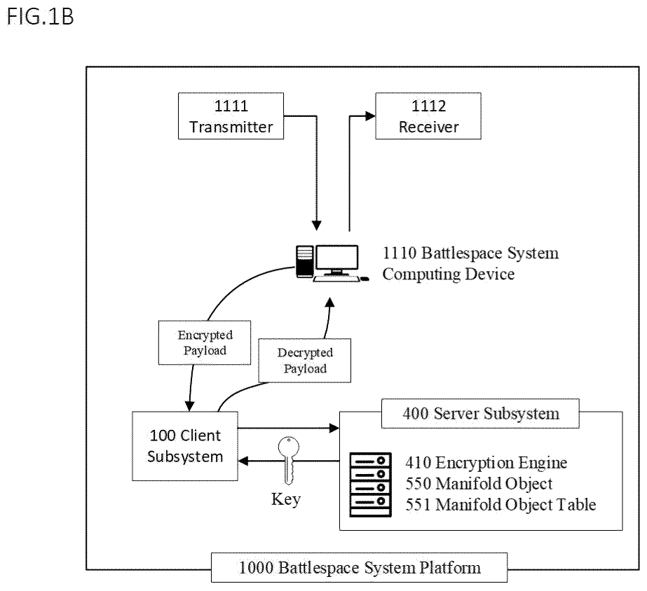

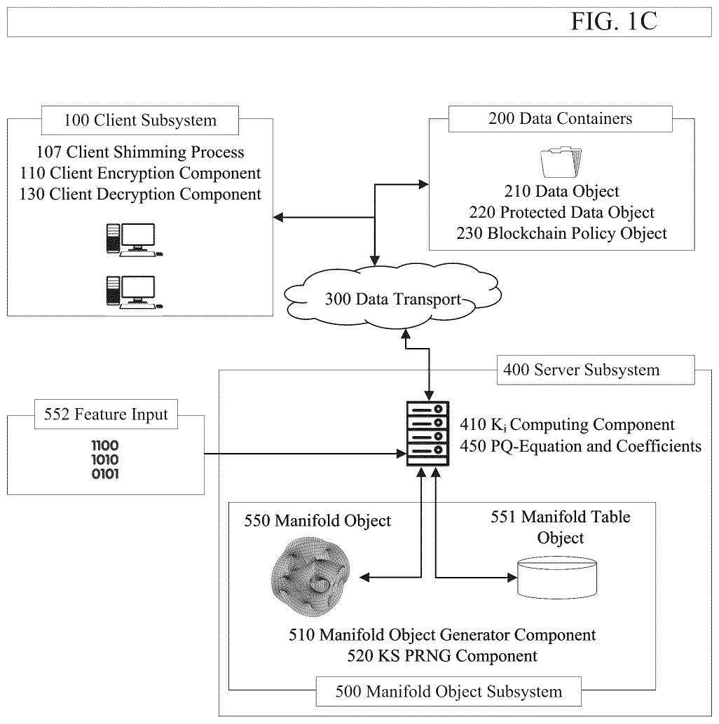

The above equations and elements are expressed in terms of the packaged cryptographic system for transforming the DO to a PDO and then destroying the transient encryption key and transmitting the data with elements to reconstitute the key as best seen in FIG. 1C shown below, but the cryptographic components are the base key in an distributed battlespace command and control system which in turn is part of an overall battlespace management system communicating with a wide variety of clients, ranging from individual units, to platforms and back again to command and control elements. This is shown in FIGS. 1A-1B.

FIGS. 1A-1B are views that illustrate the use of the cryptographic system in battlespace according to an exemplary embodiment. FIG. 1A shows modem battlespace with several elements communicating in a command and control network across multiple platforms, units, other combat systems and non-combat systems. FIG. 1B details the transactions within the battlespace for the cryptographic system with a battlespace computing device communicating with a client 100 provisioning a cryptographic key from a cryptographic server.

FIG. 1A is a schematic showing the overall architecture of the cryptographic system according to an exemplary embodiment in a battlespace. FIG. 1A is a view that illustrates the location of the 1000 cryptographic system when used in battlespace, for military applications and use. Military platforms often require data to be exchanged between a variety of platforms accomplished across management systems for C5 ISR subsystems, incorporated widely as a 1007 Data Transport mechanism in FIG. 1A. The Data Transport mechanism 1007 connects Land Platforms 1001, Seaborne Platforms 1002, Vehicle Platforms 1003, Airborne Platforms 1004, Spaceborne Platforms 1005 and Soldier Platforms 1006 and the like in this non-limiting example. When data is exchanged between the platforms, this data should be guarded and protected by encryption as part of the overall battlespace management system. The encryption system or subsystems can be singularly placed or distributed across the platforms or other components of the battlespace management system.

FIGS. 1A-1B are views that illustrate the use of the cryptographic system in battlespace according to an exemplary embodiment. FIG. 1A shows modern battlespace with several elements communicating in a command and control network across multiple platforms, units, other combat systems and non-combat systems, as noted. FIG. 1B details the transactions within the battlespace for the cryptographic system 1000 shown and the communication via a transmitter and receiver 1111,1112, respectively, with a battlespace computing device 1110 and the transmission of and return of a payload from a client 100 provisioning a cryptographic key from a cryptographic server 400.

As shown herein, several components of the instant invention enable the key provisioning system of the instant invention. These include but are not limited to Client Subsystem 100, Data Containers 200, a Data Transport Link 300, the Server Subsystem 400, and the Manifold Object Subsystem 500 and similar components, as seen in FIG. 1B. The system can be run utilizing a single agreed upon manifold server or have subsystem servers linked and securely communicating via various security protocols to provide end to end encryption through a variety of platforms. The system can be based on a zero trust architecture or similar paradigms and the encryption is a component part for maintaining authorizations within the system and/or used to encrypt data again, in the same or different subsystem(s). The instant invention is agnostic as to the encryption methodology and therefore compatible with most of the existing hardware, acting principally as a key provision or with data rights policy packets tied to the PDO and enhancing secure transmission as well as initiating key calls from the cryptographic key provisioner Server Subsystem 400.

So in the example, guarded data, also identified as a data object (DO), is any data which is considered sensitive or highly sensitive. Guarded data can include, but is not limited to Personally Identifiable Information (PII), assigned numerical identifier, sensitive battlefield data, military, defense, and other government data related to, but certainly not limited to continuity of government and the execution of humanitarian and sensitive civilian activities.

The Cryptographic System 1, including but not limited to the Client or Client Device or Client Subsystem 100, the Data Object (Guarded Data) 200, the Interface 300, The Cryptographic Server 400, the Manifold Object 550 and the Manifold Table Object 551, together represent a system that can be integrated into each platform in one exemplary embodiment. Each platform can include a Manifold Object 550 and Manifold Table Object 551 shared across all platforms or select platforms can have a unique Manifold Object 550 and Manifold Table Object 551 so that the ability for any protected guarded data can only be decrypted between a select few platforms.

The Client or Client Device or Client Subsystem 100 can include but is not limited to operational command and control data systems and assets, intelligence service data systems, communication systems, individual weapons platforms, warfighter systems, vehicle mounted data and communication systems, machine to machine data communication platforms, artificial intelligence communication and control assets, and similar systems known collectively as a battlespace management system or a component of such a system.

In a non-limiting exemplary embodiment again of FIG. 1A, for example, a military base, shown as the Cryptographic System Land Platform 1001 a component of a battlespace C4 or Command, Control, Communication, Computers, Cyber (C5) ISR system, needs to provide a replacement cryptographic key, represented as highly sensitive guarded data, to a Seaborne Platform 1002. The land base 1001 can encrypt the guarded data with the exemplary method as described herein below using a shared Manifold Object 500 and policies restricting provisioning of the key to the select Cryptographic System Seaborne Platform 1002, the ship as shown in the figure. In this method, the guarded data can be cryptographically secured and passed from Land Platform 1001 to Seaborne Platform 1002 via the Data Transport 1007 via transmission as shown. If the transmission is intercepted or compromised and received by an adversary collection systems, the adversary would be unable to decrypt the guarded data, while other platforms, including but not limited to other Seaborne Platforms 1002, Airborne Platforms 1003, etc., would be restricted by policies based on the key information provisioned by the instant invention as a cryptographic system and could not provision the cryptographic key to decrypt the guarded data. This embodiment demonstrates a one-to-one transmission and decryption of guarded data.

In a further non-limiting exemplary embodiment, a Cryptographic Soldier Platform 1006 can be carried by a warfighter on a reconnaissance mission. The individual warfighter wishes to relay an image of enemy activity via an Airborne Platform 1004 to multiple Vehicle Platforms 1003. The Cryptographic System Soldier Platform 1006 can encrypt the image using the exemplary embodiment then transmit the guarded data through an alternative relay platform, such as Airborne Platform 1004 to receiving platforms, such as Vehicle Platform 1003. This embodiment demonstrates a one-to-many transmission and decryption of guarded data.

Though shown diagrammatically in the system representation, the key provisioning component as well as the encryption components are typically contained within the electronic components—chipsets—of the individual components in the battlespace management system. The cryptographic system can for instance be, but is certainly not limited to, a hardwired circuit board within a communications bus on a particular platform or at the particular location. This can be integrated with various known physical security features to aid in making the system more robust and enhancing the overall security of the system or subsystems using the cryptographic components. The instant invention again, is agnostic to the methodology of the encryption, focusing on the provisioning of the key facilitating the encryption and rendering it transient but recoverable with the key elements, removing a common exploit in the static Cryptographic Key Management System. The instant invention providing a more robust solution for communicating the key elements with higher security, providing a wider number of unique solutions, and further limiting the accessibility to the key to a transient moment to perform the encrypt/decrypt function.

FIG. 1C is a schematic showing the overall architecture of the cryptographic system according to an exemplary embodiment. The schematic shows the cryptographic system with a Client Subsystem 100, Data Containers 200, a Data Transport Link 300, the Server Subsystem 400, and the Manifold Object Subsystem 500. As would be understood by one of ordinary skill in the art, the location of the elements can be varied to suit the limitations of a given application or system.

In the exemplary embodiment shown, the Client Subsystem 100 can include, but not exclusive of a software application, an embedded system, or a hardware computing solution; accessible by a human or machine to interface with the data objects and the server, running on a physical or virtual computer, a mobile device, cloud-based computer, web-based service, Internet of Things (IoT) device, and the like. Client Subsystem 100 possesses the Client Encryption Component 110 and the Client Decryption Component 130. In this embodiment, Client Subsystem 100 is shown separate from Server Subsystem 400; however, these subsystems can reside on a single computing device or can reside on separate computing devices.

In the exemplary embodiment shown, Data Container 200 includes digital information, such as data files, data collections, data documents in any format; unencrypted, encrypted, partially encrypted, encoded or not encoded. The stored location for a Data Object 210, a Protected Data Object 220 and the Blockchain Policy Object 230 can include, but is not limited to, a hard drive, a portable storage drive, network file system, cloud-based storage, embedded device data, IPFS, centralized and decentralized storage systems, and the blockchain.

In the exemplary embodiment shown, Data Transport 300 provides a method to communicate between the Client Subsystem 100 and the Server Subsystem 400 and is indifferent to the location and retrieval method of the Data Container 200 and is indifferent to this method's key establishment protocol. Data Transport 300 can be, but is not exclusive of, a computer network, a hardware device computing port, such as a Universal Serial Bus (USB), various wired and wireless protocols, such as Wi-Fi and Bluetooth, the World Wide Web (WWW), and the like.

In the exemplary embodiment shown, Server Subsystem 400 provides a response to the Client request, which can include, but is not limited to, the key (Kᵢ) and PQC and similar values. The server is a software-based application which runs on, but is not exclusive to a computer, server-computer, a cloud-based virtualized computer, a mobile device, an IoT device, an embedded device, a portable computing dongle, and the like. Server Subsystem 400 is responsible for accepting the Client request, processing the request and computing the cryptographic key. Based on the Client request, if for a new key, Server Subsystem 400 will create a new cryptographic key and provide the key and PCQ back to the Client. If the Client request is to recompute the key, Server Subsystem 400 will compute the key based on the provided PCQ, validate if the access policies have been met, then return a response to the Client. If the policies have been met, then Server Subsystem 400 will provide the key to the requesting Client. If the policies have not been met, Server Subsystem 400 will destroy the key and return an error to the requesting Client.

In the exemplary embodiment shown, The Manifold Object Subsystem 500 is a software application which includes the 3-dimensional Manifold (M), the Manifold Object Table (MOT) and other processes to enable the generation and recomputing of the deterministic cryptographic key (Kᵢ).

In the exemplary embodiment of FIG. 1C, Manifold Object Subsystem 500 is managed by Server Subsystem 400 to allow the Manifold Object Generator Component 510 and KS PRNG Component 520 to compute the Manifold Object 550 and populate the Manifold Object Table 551 as shown. Again, the specific management of the components can be tasked to other subsystems, but the importance is the calculation of the Manifold Object 550 and its primary intersects as explained herein to provide for a robust encryption element. The Manifold Object Generator Component 510 by use of Server Subsystem 400 permits Feature Inputs 552 to generate the manifold object. Manifold Feature Inputs 552 can be derived from a random process or a manual process.

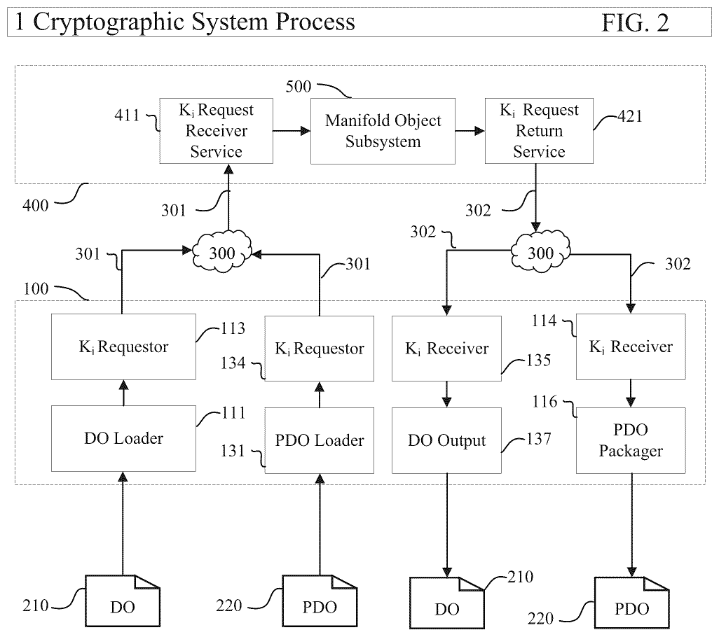

FIG. 2 is a view that illustrates the data transport, client process and server service connections according to the embodiment of FIG. 1. In the exemplary embodiment, for the flow of information between the Client Subsystem 100 to the Server Subsystem 400 across the Data Transport 300.

The general process flow for protecting a DO 210 begins with the Client Subsystem 100 at the DO Loader 111 which loads the unencrypted data object to be protected. A request is made by the Kᵢ Requestor 113 process to the Server Subsystem 400 at the Kᵢ Request Receiver 411 service, across the Data Transport 300, where 301 identifies the connections between the Client Subsystem and the Server Subsystem. The Server Subsystem 400 processes the request, communicating internally with the Manifold Object Subsystem 500. When the key has been computed the Server Subsystem 400, Kᵢ Request Return 421 service replies to the Client Subsystem 100 at the Kᵢ Receiver 114 entry point. The Client Subsystem 100 PDO Packager process 116 saves the PDO 220 to file storage as a protected data object.

The general process flow for decrypting/accessing a PDO 220 begins with the Client Subsystem 100 at the PDO Loader 131, which loads the protected data object. A request is made by the Kᵢ Requestor 134 to the Server Subsystem 400 at the Kᵢ Request Receiver 411 service, across the Data Transport 300, where 301 identifies the connections between the Client Subsystem and the Server Subsystem. The Server Subsystem 400 processes the request, communicating internally with the Manifold Object Subsystem 500. When the key has been computed the Server Subsystem 400, Kᵢ Request Return 421 service replies to the Client Subsystem 100 at the Kᵢ Receiver 135 entry point. The Client Subsystem 100 DO Output 137 process saves the DO 210 to file storage as a decrypted data object.

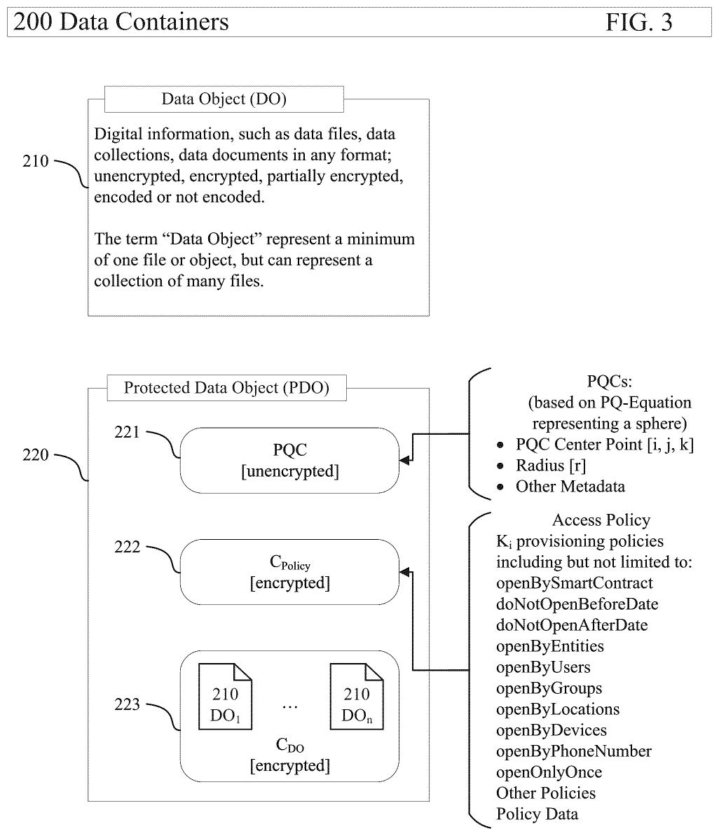

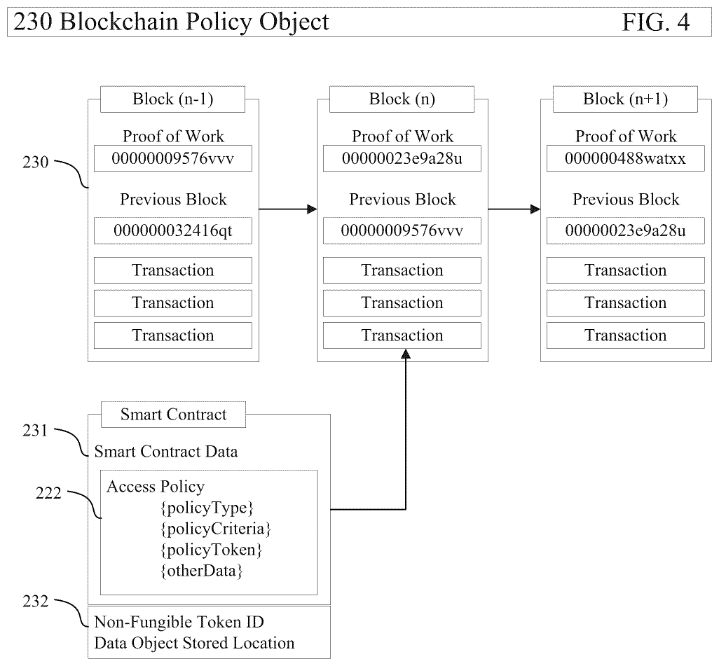

FIGS. 3 and 4 illustrate Data Containers 200 comprising Data Object 210 (DO), Protected Data Object 220 (PDO) and Blockchain Policy Object 230 respectively. The DO 210 can be, but is not limited to, digital information, such as data files, data collections, and data documents in any format; unencrypted, encrypted, partially encrypted, encoded or not encoded. PDO 220 can be, but is not limited to, an archive-like data object, which includes but is not limited to data blocks PQC 221, PDO Access Policies (C_{Policy}) 222, and encrypted DO's (C_{DO}) 223, which permit per-data object encryption with access policies needed to compute Kᵢ. The Blockchain Policy Object 230 are policy instructions and descriptive information that identifies a PDO, formatted to adhere to a blockchain smart contract protocol.

FIG. 3 is a view which illustrates data containers, which are the unprotected and protected data object according to the embodiment of FIG. 1. The PQC 221 data block is inside the PDO, which stores the polynomial/quadratic coefficients necessary to compute Kᵢ. PQC includes the polynomial or quadratic coefficients and other metadata, which, for the exemplar of a sphere, can include Center Point [i,j,k] and radius [r].

PDO Access Policies (C_{Policy}) 222 are instructions which inform the Policy Actions process on the procedures to achieve an intended outcome for the returning Kᵢ to the requesting Client. The following is a non-exhaustive list of possible access policies, which can include but are certainly not limited to:
Do Not Open Before Date
Do Not Open After Date
Open By Entities
Open By Users
Open By Groups
Open By Locations
Open By Devices
Open By Access Numbers
Open Only Once
Open attempt alerts
   Encrypted DO's (C_{DO}) 223 are Data Objects, which have been encrypted using a standard encryption algorithm with Kᵢ used as the cryptographic key.

FIG. 4 is a view which illustrates the PDO access policy integrated into a blockchain smart contract with Non-Fungible Token (NFT). The exemplary embodiment of the method is shown, by which the cryptographic system of the instant invention can incorporate a Blockchain Policy Object 230 into blockchain contracts. In the embodiment of the invention shown in FIG. 1, the embodiment can integrate the PDO Access Policy 222, via the Blockchain Policy Object 230, into a blockchain smart contract as a non-limiting example. One non-exclusive example of accomplishing this embeds the PDO Access Policy 222 type, criteria, a token and other data into the blockchain Smart Contract using the encryption process of the instant invention. When the criteria have been met for the selected policy type, the token is released to the Server Subsystem 400, allowing the key generating service to compute Kᵢ for decryption of the PDO. For some data objects, such as eyes only documents, a Non-Fungible Token (NFT) or similar authenticating solution can be associated with the PDO as a digital certificate of authenticity.

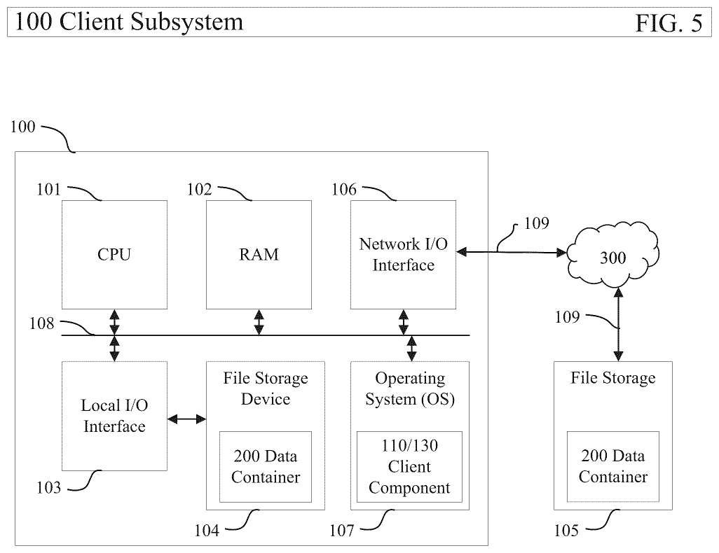

FIG. 5 is a view showing the components of an exemplary embodiment of the client subsystem. In the plan view of a client side of the subsystem it is shown as a network enabled exemplary embodiment of the invention. The Client Subsystem 100 provides a human or machine interface to access a DO or PDO, requests Kᵢ, and encrypts the DO into a PDO or decrypts the PDO. The Client Subsystem 100 can include but is not limited to a CPU 101 for computing and processing, non-persistent memory storage RAM 102, local input/output interface 103 to communicate with client-side hardware and services such as the file storage device 104 and network-like storage devices and services 105 via the network input/output interface 106 across a data transport communication path 109 and 300, the Operating System (OS) 107 and the client communication bus 108. In the non-limiting exemplary embodiment shown in FIG. 5 operating system 107 provides the Application Program Interfaces' (API) for software, such as the Client Components 110 and 130, can access client subsystem resources. In this exemplary embodiment, the client-based software, which can include a User Interface/User Experience (UI/UX) for human or a machine-based interface is used to interact with the DO, PDO, OS, encryption/decryption algorithms and computer components. Collectively, the client components utilize the computer resources to encrypt a DO into a PDO and decrypt a PDO into a DO.

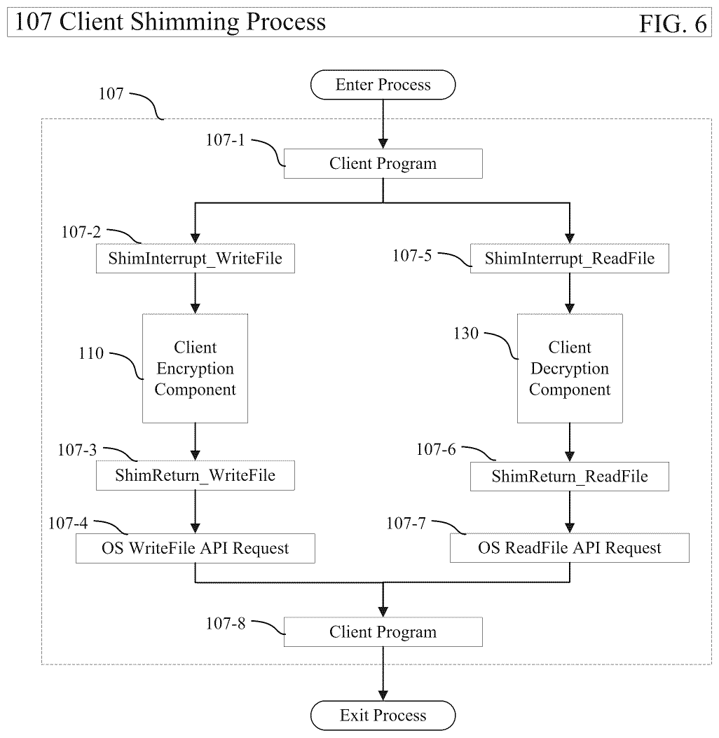

FIG. 6 show the process flow that illustrates the respective exemplary embodiments of Client Shimming which permits Client Subsystem 100 to interact with standard computer programs by intercepting and redirecting API calls from the operating system to the subsystem. The shimming process boxes the Client Encryption Subsystem 100. Again, this process can be incorporated into existing encryption systems and supplant the key management process/files currently used or incorporate same into the key provisioning process. This process, when activated in Client Subsystem 100, allows seamless integration with other programs to streamline interaction client programs, such as but not exclusive of voice communication or similar programs, and the operating system to enable to the client programs built-in functions to call Server Subsystem 400 as an action prior to the intended OS action as is well known and understood in the industry. An example of this process would be to use the client program “open” function to open a PDO; however, the shim 107-5 interrupts the OS call ReadFile and executes a separate call to load the PDO into memory and passes control to the Client Decryption Component 130 to transform the PDO into a DO, then returns control 107-6 back to the client program, allowing the program to access the unencrypted data. Shimmed OS Application Server Interface (API) commands include for example, but are not limited to read, write, update, create, delete, and the like. A client shim process is provided as part of the exemplary embodiment where the encrypt and decrypt process are integrated to function with client devices in normal operation as a layer between the operating system and the data objects.

FIG. 6 shows an exemplary configuration of the Client Shimming process; saving a DO to data storage as a PDO and loading a PDO from data storage. In the exemplary configuration where a client program takes action to save a DO to file storage, the ShimInterrupt WriteFile 107-2 acts as interface between the client program 107-1 and the OS WriteFile API Request 107-4. The client program 107-1 calls to save a DO, is intercepted by 107-2 and redirects the call to the Client Encryption Component 110. After completion of 110, the ShimReturn_WriteFile process 107-3 is returned to the OS WriteFile API 107-4, which then returns control to the client program 107-8. In the exemplary configuration where a client program takes action to open a PDO from file storage, the ShimInterrupt_ReadFile 107-5 acts as interface between the client program 107-1 and the OS ReadFile API Request 107-7. The client program 107-1 calls to open a PDO, is intercepted by 107-5 and redirects the call to the Client Decryption Component 130. After completion of 130, the ShimReturn_ReadFile process 107-6 is returned to the OS ReadFile API 107-7, which then returns control to the client program 107-8.

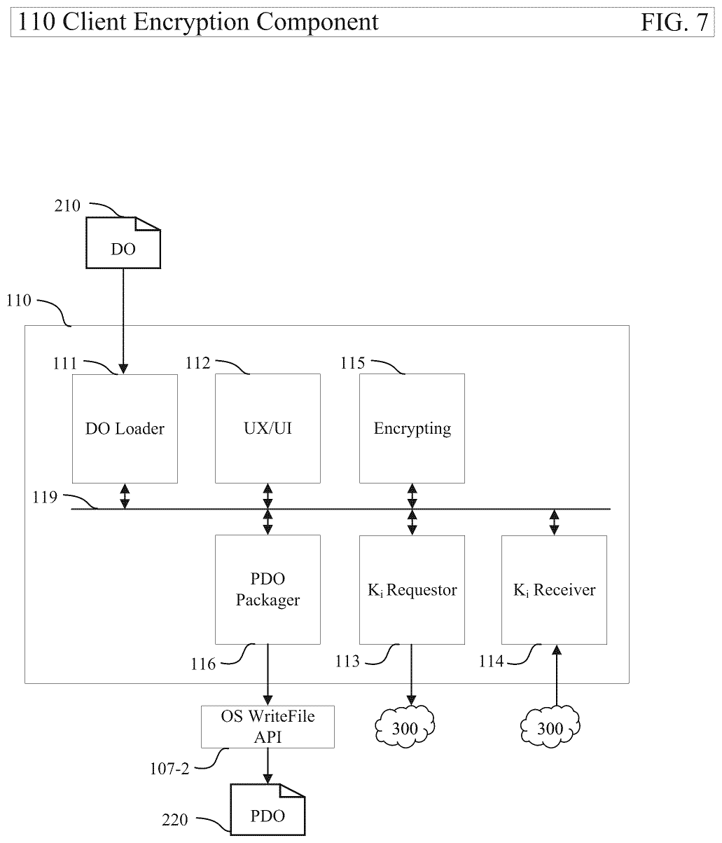

FIG. 7 is a view showing an exemplary embodiment of the client encryption component. It is a non-limiting example of a Client Encryption Component 110. The Client Encryption Component 110 provides a method for users or process to interface with Data Containers 200 and the Server Subsystem 400 in order to perform the functionality in the exemplary embodiment of FIG. 1. Client Encryption Component 110 loads the DO 210, allows the user or process to apply policies, requests the cryptographic key, encrypts Data Objects 210 into Protected Data Objects 220 when called upon by a user, program, or similar process initiating encryption of data and saves the PDO 220 to digital storage. In a non-limiting exemplary embodiment of FIG. 7, the Client Encryption Component 110 can be initiated by a shimming process as illustrated in FIG. 6 or as a stand-alone application operating apart from a shimming process.

In this non-limiting exemplary embodiment, the DO Loader 111 loads the Data Object 210 from file or memory storage, such as, but not limited to, a part of the Random Access Memory (RAM) 102 or temporary storage on a File Storage Devices 104 such as, but not limited to, a hard drive or stored in temporary storage such as remotely on a network drive or the cloud. User Experience/User Interface UX/UI 112, generally idealized as a Graphical User Interface (GUI) or a command line interface to a user or process, or other experience which can include but would not be limited to, voice commands, visual commands, touch commands and similar user inputs, provides a user a method to select Access Policies and attributes to assign to the Protected Data Object 220. The Kᵢ Requestor 113 acts as an interface, via the Data Transport 300, with the Server Subsystem 400 to issue a request for the cryptographic key. The Kᵢ Receiver 114 acts as an interface to receive, via the Data Transport 300, the cryptographic key (Kᵢ) and the PQC 221 for the key, from the Server Subsystem 400. The Encrypting 115 process creates a PQC data block, creates an encrypted PDO Access Policy data block (Policy→C_{Policy}), encrypts each DO into a data block (DO_{1, 2, . . . n}→C_{DO}). The PDO Packager 116 assembles each data block into an archive (PCQ+C_{Policy}+C_{DO}→PDO) and saves to data storage 107-2. The Client Encryption Subsystem 110 is enabled by the bus 119, which facilitates communication between the processes.

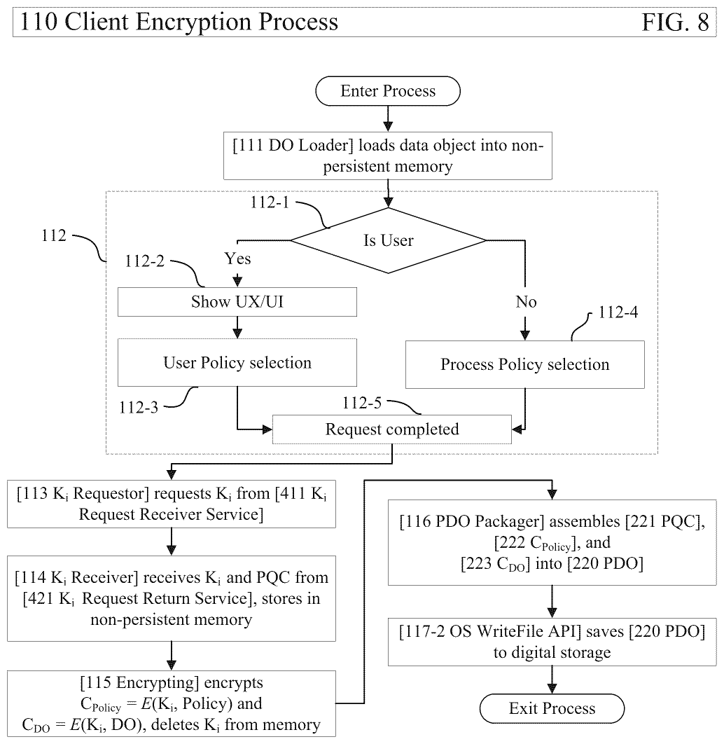

FIG. 8 is a process flow chart view showing an exemplary embodiment of the client encryption process. FIG. 8 illustrates the respective exemplary embodiments of the Client Encryption Process for the non-limiting exemplary embodiments of the invention in FIG. 7. As shown in FIG. 8, the process begins with a call to DO Loader 111, which can include, but is not limited to, a shimming process call from a client program or initiation by a user or a computing process. A step of loading the data object into memory is conducted. The DO Loader 111 loads the Data Object 210 into Random Access Memory (RAM) 102 or temporary storage on a File Storage Devices 104. A determination is made as to the type of user 112-1. Depending on the result of the determination, different process paths provide for user selected policies or process policies to be applied during encryption. For instance, if a human is the user 112-1, then a UX/UI is displayed 112-2 allowing the user to make selections, including access policy selections 112-3, otherwise if an automated computing system is used, then the automated process processes the access policy selection criteria 112-4.

After the access policy selection is completed 112-5, a request is made for the cryptographic key. In the exemplary embodiment shown, this is done by the Kᵢ Requestor 113. The Kᵢ Requestor submits a request across the Data Transport 300 to the Server Subsystem 400. A receiving step occurs whereby the key, Kᵢ, and other variables are received by the Client Encryption Component 110. The Kᵢ Receiver 114 receives the cryptographic key (Kᵢ), and polynomial and quadradic equation coefficients (PQC) and stores Kᵢ and PQC into non-persistent RAM 102.

An encryption step is performed on the DO to form the PDO. The exemplary embodiment shown has Encrypting 115 process call Kᵢ from, in a non-limiting example, RAM 102 and encrypts the Policy data block as C_{Policy} 222 using Expression (16), where P=Policy and the DO as C_{DO} 223 using Expression (16), where P=DO. When the encryption process is complete, Kᵢ is deleted from memory. Following the encryption step, the PDO Packager 116 assembles the PQC data block 221, C_{Policy} data block 222 and the C_{DO} data block 223 into a Protected Data Object 220 and calls OS WriteFile API 107-2 to save object to file storage.

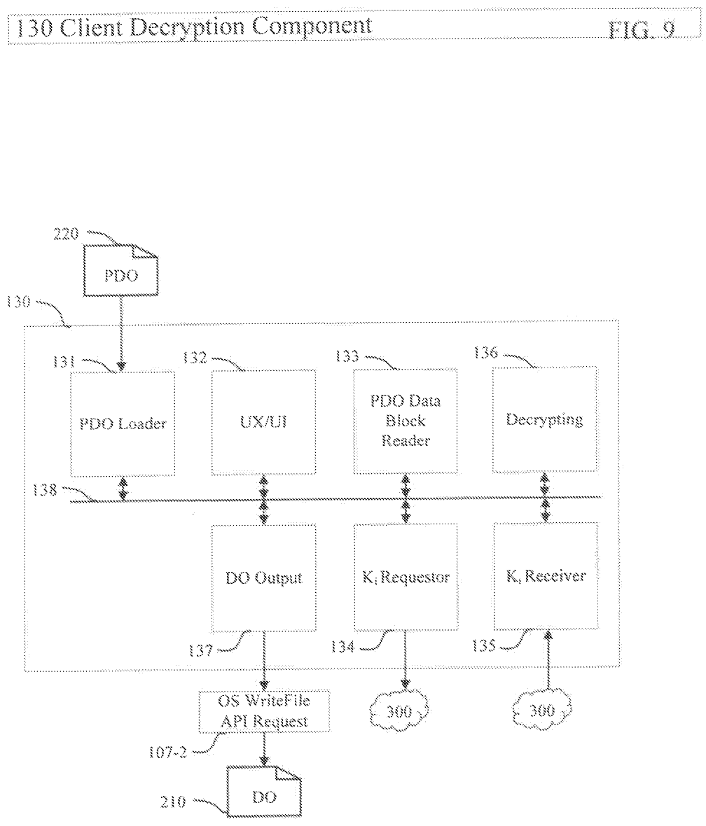

FIG. 9 is a view showing an exemplary embodiment of the client decryption component. The view shows a non-limiting example of a Client Decryption Component 130. The Client Decryption Component 130 provides a method for users or process to interface with Data Containers 200 and the Server Subsystem 400 in order to perform the functionality in the exemplary embodiment of FIG. 1. Client Decryption Component 130 loads the PDO 220, requests the cryptographic key, decrypts Protected Data Objects 220 into Data Objects 210 when called upon by a user, program, or similar process initiating decryption of data and saves the DO 210 to digital storage. In a non-limiting exemplary embodiment of FIG. 9, the Client Decryption Component 130 can be initiated by a shimming process as illustrated in FIG. 6 or as a stand-alone application operating apart from a shimming process.

FIG. 9 illustrates the Client Decryption Component 130. In this non-limiting exemplary embodiment, the PDO Loader 131 loads the Protected Data Object 220 from file or memory storage, such as, but not limited to, a part of the Random Access Memory (RAM) 102 or temporary storage on a File Storage Devices 104 such as, but not limited to, a hard drive or stored in temporary storage such as remotely on a network drive or the cloud. User Experience/User Interface UX/UI 132, generally idealized as a Graphical User Interface (GUI) or a command line interface to a user or process, or other experience which can include but would not be limited to, voice commands, visual commands, touch commands and similar user inputs, provides a user a method to respond to Access Policies requests. These requests can include, but are not limited to, providing an alpha-numeric pin, password, biometric input such as face or fingerprint, or other, as required by the Access Policy.

The PDO Data Block Reader 133 reads from the PDO, the PQC data block and C_{Policy} data block to submit to Server Subsystem 400. The Kᵢ Requestor 134 acts as an interface, via the Data Transport 300, with the Server Subsystem 400 to issue a request for the key. The Kᵢ Receiver 135 acts as an interface to receive, via the Data Transport 300, the key, Kᵢ, from the Server Subsystem 400. Decrypting 115 process decrypts the C_{DO} data block into unencrypted data objects (C_{DO}→DO_{1, 2, . . . n)}). The DO Output 137 saves the decrypted data object to data storage 107-2. The Client Decryption Process 130 is enabled by the bus 138, which facilitates communication between the processes.

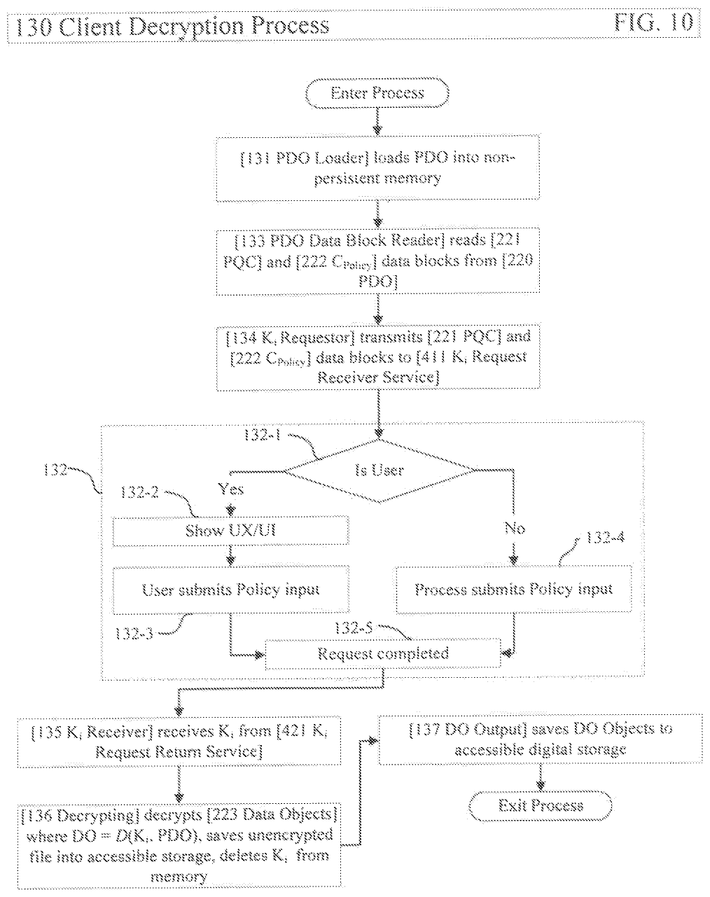

FIG. 10 is a process flow chart showing an exemplary embodiment of the client decryption process. The figure shows the process flow that illustrates the respective exemplary embodiments of the Client Decryption Process for the non-limiting exemplary embodiments of the invention in FIG. 9. On loading of the application, the process begins with a call to PDO Loader 131, which can include, but is not limited to, a shimming process call from a client program or initiation by a user or a computing process for example. A step of loading the protected data object into memory is conducted. The PDO Loader 131 loads the Protected Data Object 220 into Random Access Memory (RAM) 102 or temporary storage on a File Storage Devices 104.

In the exemplary embodiment shown, the PDO Data Block Reader 133 reads the data blocks PQC 221 and C_{Policy} 222 from the PDO 220. The Kᵢ Requestor 134 transmits a request across the Data Transport 300, which includes the PQC 221 and C_{Policy} 222 data blocks to the Server Subsystem 400 to compute the cryptographic key (Kᵢ).

A determination is made as to the type of user 132-1. Depending on the result of the determination, different process paths provide for input to user selected policies or process policies, which were applied during encryption. For instance, if a human is the user 132-1, then a UX/UI is displayed 132-2 allowing the user to respond to a policy request, such as an alpha-numeric pin, password, biometric input such as face or fingerprint, or other, as required by the Access Policy 132-3, otherwise if an automated computing system is used, then the automated process processes the policy selection criteria 132-4. The policy response is provided to Server Subsystem 400 to validate the Access Policy has been met.

The Kᵢ Receiver 135 receives the cryptographic key (Kᵢ), which is passed to the Decrypting 136 process. The elements of the decryption process principally vary in Decrypting 136, which reverses the computational processes of the Encrypting 115 process. An embodiment having both the encryption and decryption components in the same physical subsystem is contemplated as well. Decrypting 136 process decrypts the PDO and the DO Output 137 process saves the DOs to file storage 104 via the OS WriteFile API Request 107-2 or saves the DO into RAM 102. The Client Decryption Component 130 is enabled by the bus 138, which facilitates communication between the processes.

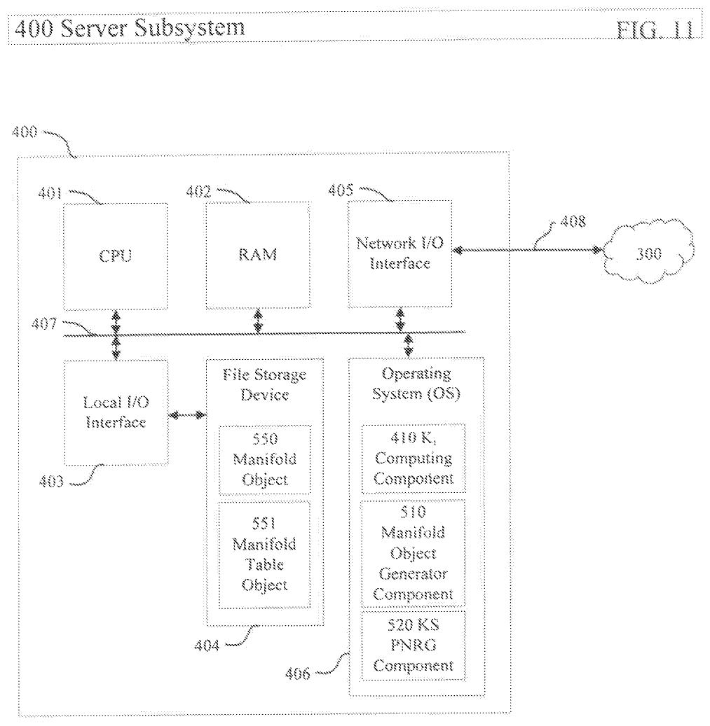

FIG. 11 is a view which shows a non-limiting example of the Server Subsystem 400 of a network enabled exemplary embodiment of the invention. As shown in FIG. 11, the Server Subsystem 400 can include, but is certainly not limited to, at least one CPU 401 for computing and processing, non-persistent memory storage RAM 402, an at least one local input/output interface 403 to communicate with server-side hardware and services such as the file storage device 404, a network input/output interface 405 across a network communication path 408 and 300, the operating system 406 and the server communication bus 407. The exemplary embodiment of the server runs the various application processes which enable the exemplary embodiment of this invention as described herein above.

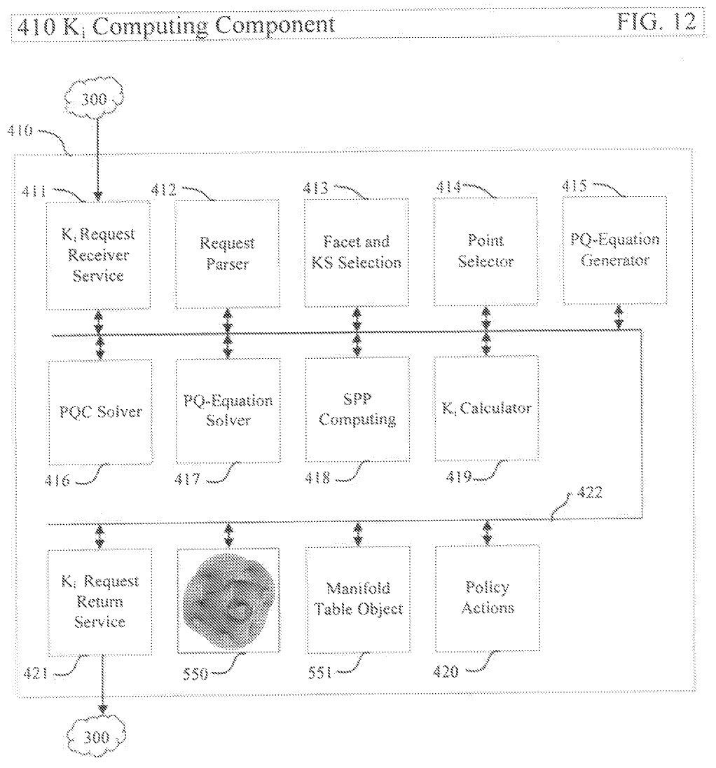

FIG. 12 is a view showing an exemplary embodiment of the Kᵢ computing component according to the embodiment of FIG. 1. A non-limiting example of a cryptographic key generator component of the instant invention is shown, called the Kᵢ Computing Component 410, which can be a component of the Server Subsystem 400, as shown in this exemplary embodiment, coupled to the Data Transport 300. The component obviates the need for a Cryptographic Key Management System (CKMS); however, the cryptographic system does not exclude a CKMS from the system, which can be desirable for authorization to use the Kᵢ Computing Component resources. The Kᵢ Computing Component computes the cryptographic key, Kᵢ, by combining Other Data D₁, or PQC 221, which is held in the PDO 220, accessible only by the Client Subsystem 100, Other Data D₂, or SPP 456, which is computed by the component with PQC as the input to the expression, and K₃. Component key K₃ is held on the Server Subsystem 400 in a protected database, called the Manifold Table Object 551 and is not accessible by the Client Subsystem. The elements, or Other Data, used to compute Kᵢ, after being computed, is stored in the PDO as the PQC data block 221. The PCQ is provided to the Kᵢ Computing Component 410 to compute Kᵢ, using Expression (4) in this exemplary embodiment. The component key K₂ does not exist and can only be derived when the Client Subsystem provides the PQC 221 to the Server Subsystem 400 to calculate K₂ from the SPP, using Expression (6). Only when the Server Subsystem possesses Kᵢ, K₂ and K₃ can Kᵢ be computed, using Expression (1), Expression (2) or a combination of the two. The Server Subsystem 400 does not require the PDO to perform the decryption into unencrypted data objects; therefore, confidentiality of the information remains with the client device.

The Kᵢ Computing Component 410 includes, but are certainly not limited to, the Kᵢ Request Receiver 411, which receives the request for Kᵢ from the Client Subsystem 100 over the Data Transport 300 as shown in FIG. 12. The Request Parser 412 extracts the data blocks PQC 421 and C_{Policy} 422 from the client request message. The Facet and KS Selection 413 randomly selects a facet used in the computation of a new Kᵢ from the Manifold Table Object 551. The Point Selector 414 randomly computes a geographic point on the facet, represented by (m, n, o) identified as the SPP 456. The PQ-Equation Generator 415, computes the coefficient properties of the polynomial or quadratic equation or surface.

PQ Solver 416 solves for the intersection of the equation with the manifold at the SPP, where the SPP is perpendicular to the facet surface. This computation creates a unique point where the SPP can be recomputed, but remains unknown until computed. The PQ-Equation Solver 417 is used to process the PQC coefficients, provided by the Client Subsystem 100, and solve for the polynomial or quadratic equation overlaid onto the Manifold Object 550. The SPP Computing 418 process computes the SPP on the facet, allowing the Server Subsystem to compute component key K₂. The Kᵢ Calculator 419 computes Kᵢ from the component keys, using Expression (1), Expression (2) or a combination of the two. The Policy Actions process 420 decrypts C_{Policy} and evaluates the policies to determine if the policy conditions have been met.

If policy conditions have been met, Kᵢ is provided to the Client Subsystem to decrypt C_{DO} into unencrypted data objects. If policy conditions have not been met, Kᵢ is nullified and the Client Subsystem would be unable to decrypt the PDO. The Kᵢ Request Return 421 service returns the appropriate data to the Client Subsystem over the Data Transport 300. Prior to exiting, the memory is cleared from the results of the process in the exemplary embodiment shown. The Manifold Object 550 and Manifold Table Object 551 are present on the Server Subsystem. The methods communication bus is represented by 422, which permits the subsystem processes to communicate.

This component provides a method to generate a cryptographic key (Kᵢ), whose key space has high entropy and randomness with a low memory volume storage need. The mathematical coefficients used to derive Kᵢ are divided into three components; one: PQC, provided to the Client Subsystem for storage into the Protected Data Object, two: the computed SPP value, which is deleted or rendered inaccessible after use, and three: the Key Seed, stored in the Manifold Table Object 551. This method allows Kᵢ to be used then deleted, while permitting a mathematical method to recompute Kᵢ. This process permits a high entropy, random, deterministic symmetric cryptographic key, which can be deleted and recomputed; therefore, the key is ephemeral. While one purpose of the component is to compute Kᵢ, another purpose provides a method to embed key management provisioning policies into the key agreement protocol.

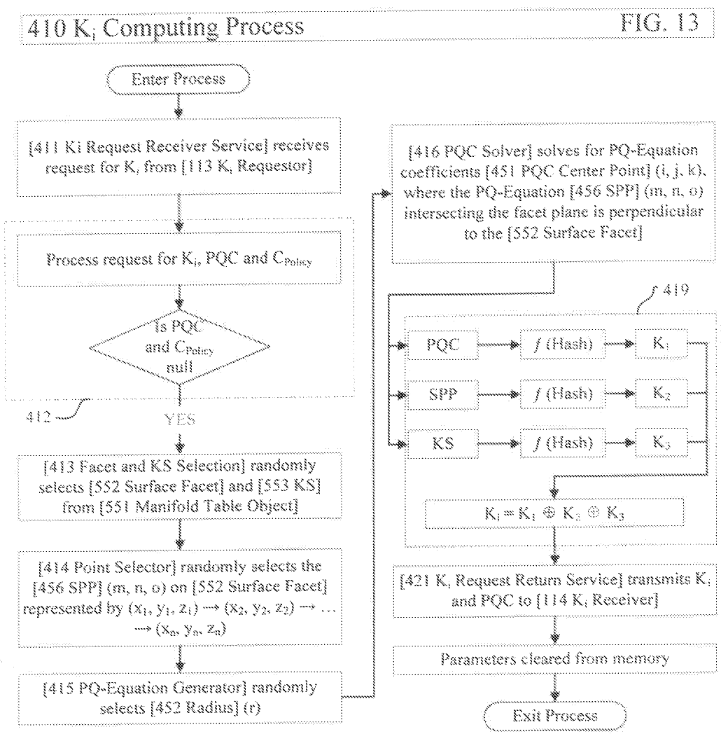

FIG. 13 is a process flow chart showing an exemplary embodiment of the Kᵢ computing process when PQC and C_{Policy} are null according to the embodiment of FIG. 12. The figure shows the process flow that illustrates the respective exemplary embodiments of the Kᵢ Computing Process 410 of the invention generating a new cryptographic key in response to a new request. A new key request is called for in a first step. The call for Kᵢ, as shown in exemplary embodiment, is generated by the Client Encryption Component 110 and enters the process at Kᵢ Request Receiver 411 service. A parsing step follows to verify request data. In the exemplary embodiment, the request message is passed to the Request Parser Receiver 412 to determine if data blocks PQC 221 and C_{Policy} 222 are in the message or is null. If there is no verifiable data indicating a former key, then a new key request is made and a facet selection is done. In this example, if the data blocks are null, the request is for a new key, Kᵢ, and the request is passed to the Facet and KS Selection 413 process. The Facet and KS Selection 413 process randomly selects a Surface Facet 552 and its corresponding facet properties and associated Key Seed (KS) 553 from the Manifold Table Object 551, and loads into RAM 402.

Surface Facet 552 properties are expressed:

$$( {x}_{1} , {y}_{1} , {z}_{1} ) \to ( {x}_{2} , {y}_{2} , {z}_{2} ) \to … \to ( {x}_{n} , {y}_{n} , {z}_{n} ) \qquad ( 19 )$$

For an exemplary embodiment of the invention generating a new cryptographic key in response to a new request, surface perpendicular point selection step is conducted. In the exemplary embodiment this is performed by the Point Selector 414 process which randomly selects a point on Surface Facet 552 as the Surface Perpendicular Point (SPP) 456 as represented by (m, n, o). This method embodies a sphere as shown in the non-limiting exemplary embodiment of the figure and uses a quadratic surface equation, Expression (15). In this embodiment, the PQ-Equation Generator 415 process randomly selects Radius (r) 452, representing the offset from the SPP to the sphere's center. The PQC Solver 416 solves for the PQ-Equation coefficients;

PQC Center Point 451 is Expressed (i,j,k) (20)

The exemplary embodiment then performs an at least one component key calculation step. In the exemplary embodiment, Kᵢ Calculator cryptographic 419 process, using Expression (4), converts the PQC coefficients into K₁, using Expression (6), then converts the SPP coefficients into K₂ and using Expression (8), converts KS into K₃. Upon calculation of all three component keys, using Expression (1), Expression (2) or a combination of both, Kᵢ is computed. The finished key, Kᵢ, is then transmitted in a return transmission process. In the exemplary embodiment, Kᵢ and the PQC 221 are then transmitted to the Client Encryption Component 110 over the Data Transport 300 by Kᵢ Request Return 421 service.

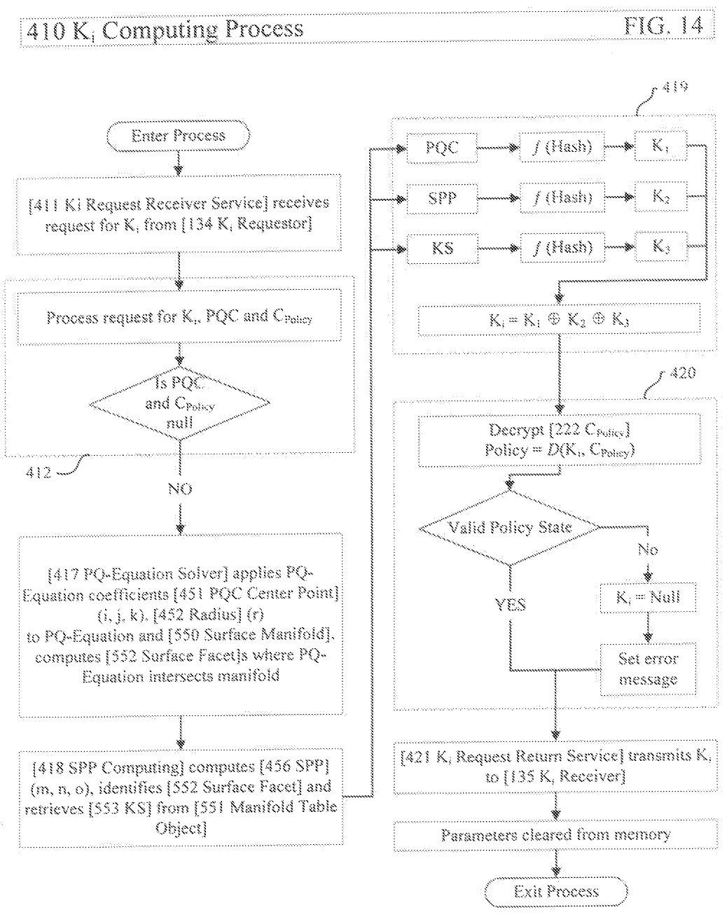

FIG. 14 is a process flow chart showing an exemplary embodiment of the Kᵢ computing process for PQC and C_{Policy} is not null according to the embodiment of FIG. 12. The process flow illustrates the respective exemplary embodiments of the Kᵢ Computing Process 410 of the invention recomputing a cryptographic key in response to a request in order to decrypt a C_{DO} into an unencrypted data object. FIG. 14 is similar at the start to FIG. 13; however, a request to recompute the cryptographic key is called for in a first step. The call for Kᵢ, as shown in exemplary embodiment, is generated by the Client Decryption Component 130 and enters the process at Kᵢ Request Receiver 411 service. A parsing step follows to verify request data. In the exemplary embodiment, the request message is passed to the Request Parser Receiver 412 to determine if data blocks PQC 221 and C_{Policy} 222 are in the message or is null. After this determination, the data related to the key is sent to a key generating service to reconstruct the key. In this exemplary embodiment, the PQC 221 is passed to the PQ-Equation Solver 417 process. The polynomial or quadratic equations are solved to identify the associated Surface Facet 552 and Key Seed 553 from the Manifold Table Object 551. Using the PQC and Surface Facet properties, the SPP Computing 418 process computes the SPP 456.

A call is then made to a key calculating process. Here, the Kᵢ Calculator 419, using Expression (4), converts the PQC coefficients into Kᵢ, using Expression (6), converts the SPP coefficients into K₂ and using Expression (8), converts KS into K₃. Upon calculation of all three component keys, using Expression (1), Expression (2), or both, Kᵢ is computed. After recalculating the key, a check is made against the policies that are stored with the key to determine if release of the key by the Server Subsystem 400 is allowed. In the exemplary embodiment of FIG. 14, the Kᵢ and C_{Policy} 222 is passed to the Policy Actions 420 process. Policy Actions process, using Expression (17) decrypts C_{Policy} and assesses the policy and action requirements. If the access policy is not met, then Kᵢ is nulled. A nulled key prevents decryption of the PDO, since the key does not represent the key used to encrypt the data object into the PDO. Therefore, the Client Decryption Component 130, or any other process, is prevented from decrypting the protected data objects. If the policy is met, then Kᵢ is then transmitted to the Client Decryption Component 130 over the Data Transport 300 by Kᵢ Request Return 421 service. After transmitting Kᵢ, the parameters used to compute the key are cleared from memory.

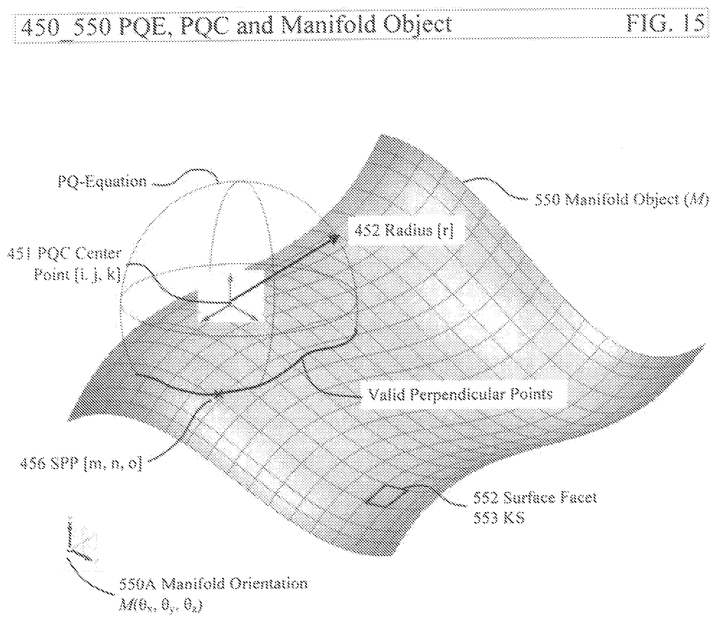

FIG. FIG. 15 is a 3-D graphical illustration showing an exemplary embodiment of a PQ-Equation and PQC mapped to the manifold and the facet. The figure shows a 3-dimensional graphical illustration representing the manifold and PQ equation interaction. In the exemplary embodiment of the invention which illustrates the PQ equation, represented as a sphere interacting with a section of the Manifold Surface. The Manifold Object (M) 550 can be represented by, but is certainly not limited to, Expressions (9), (10), and (11), a manifold is defined as topological space that locally resembles Euclidean space, taking a geometric object [symbol] and fitting into [symbol] , n>k and additional properties, such as but not limited to the Manifold Orientation 550A.

The Manifold Object is decomposed into Surface Facets 552, which represents a finite closed area and can be represented by three or more vertexes that define the area, represented by Expression (12). Each Surface Facet 552 is assigned a Key Seed 553. The Key Seed adds additional security to the cryptographic system by ensuring an unknown random value is added to the key generating process to prevent future ultra-high-performance computers or novel techniques from arbitrarily computing the total key space defined by the PQ-Equation.

The PQ-Equation, in this and other exemplary embodiments can be represented by a polynomial, idealized in Expressions (13), a quadratic equation, idealized in Expressions (14) representing a one-dimensional curve or closed curve and a quadratic surface, idealized in Expressions (15), such as a sphere or ellipse. The coefficients of the PQ-Equation, are represented by PQC 221. As illustrated in this embodiment, these properties derive from, but not limited to, those of a quadratic sphere, the properties of the PQC include the spheres PQC center 451 and the spheres Radius 452 as non-limiting examples. The PQ-Equation can intersect the manifold at an n-number of exclusive locations, however, SPP 456, can be computed when combining the PQ-Equation and the PQ-Equation coefficients (PQC) with the Manifold. In this embodiment as described, the SPP is a point where the PQ-Equation intersects the manifold surface facet and is perpendicular at the intersection; however, the SPP could be defined as a tangent or other defining mathematical property.

Although a sphere and radius solution are depicted in the non-limiting exemplary embodiment of the instant invention shown in FIG(s). 13, 14 and 15, additional embodiments can utilize different geometric shapes and equations to establish the facet and intersection points between the PQ Equation and the Manifold and used in determining the SPP solution outlined herein below. This can include any polynomial or quadratic equation for instance, but is certainly not limited to, a line, a curve, an ellipsoid, a toroid, a cone, and similar geometric shapes and equations. For instance, in the case of a circle, the properties that describe the one-dimensional line in 3-dimension space, such as its center point, the angle of rotation along the axis, and radius could be used to uniquely identify a point where the circle crosses a manifold and is perpendicular at the manifolds surface. The properties that describe the circle would be stored as the PQC in the PDO.

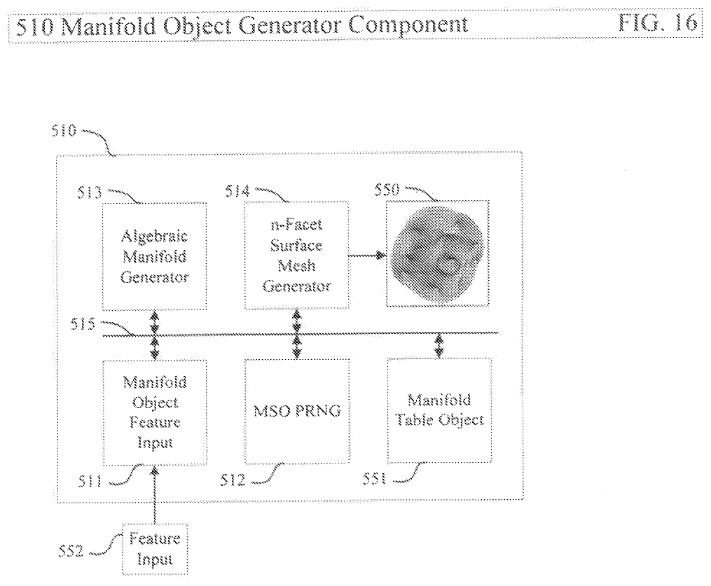

FIG. 16 is a view which shows a non-limiting example of a Manifold Object Generator Component generating a manifold as seen in FIG. 15. The component described is a non-limiting exemplary embodiment and generates a Manifold Object (M) 550. The components can include but are not limited to at least one Manifold Object Feature Input 511, at least one MSO PRNG 512, at least one Algebraic Manifold Generator 513, at least one n-Facet Surface Mesh Generator 514, at least one Manifold Object 550, and at least one Manifold Table Object 551. Additional components can be included and some elements, for instance the Manifold Object Feature Input 511, can be varied or automated without departing from the spirit of the invention. The Manifold Object Feature Input 511. The component operates to provide the manifold used in the encryption of the instant invention. It includes generating a n-Facet surface mesh on the manifold object, creating and storing a table of facets in an at least one manifold table object for lookup and manipulation in the encryption process.

The exemplary embodiment shown allows a user or process to provide Feature Inputs 552 into M, which can include but are not limited to, the Manifold Orientation 550A, dimensionality M(Rⁿ), maximum average dimensional aspect of a Surface Facet 552 and similar variables. The system can allow for user input to select the variables or the system can automatically and randomly select the variables. The MSO PRNG 512 process generates the Manifold Seed Object (512C), used by the Algebraic Manifold Generator 513. The Algebraic Manifold Generator 513 generates the manifold, M, in 3-dimensional Euclidean space, the n-Facet Surface Mesh Generator 514, which uses finite element and surface generation techniques, generates Surface Facets 552. The elements of the Manifold Object 550, which is an output of the Manifold Object Generator and the n-Facet Surface Mesh Generator 514 are saved into the Manifold Table Object 551, which is a database the stores the data required for the component to compute the SPP.

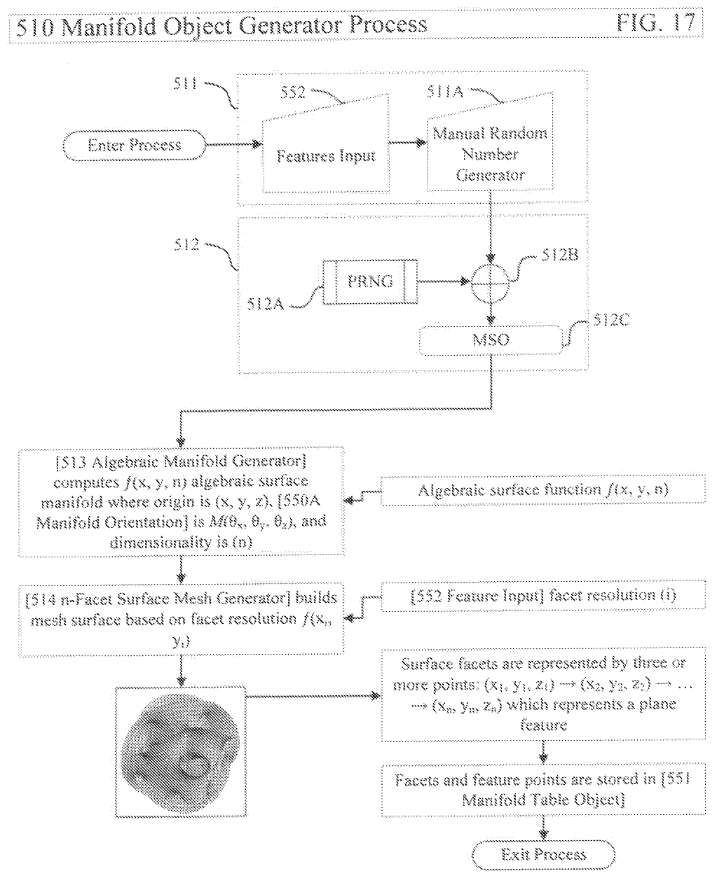

FIG. 17 is a process flow chart showing an exemplary embodiment of the manifold object generator process of FIG. 16. The figure shows the process flow that illustrates the respective exemplary embodiments of the Manifold Object Generator Process 510. The process begins with the step of obtaining input for the features of the manifold. In FIG. 17, the process enters at the Manifold Object Feature Input 511, which provides the user or process a UX/UI to input the Manifold Object Features 552 for the system, including Manifold Orientation 550A, dimensionality M(Rⁿ), and maximum average dimensional aspect of a Surface Facet (i).

Randomness in creation of the manifold aids in security. The process contemplates both user input and machine input to aid in randomizing the manifold features. In order to prevent Pseudorandom Number Generator (PRNG) process from generating predicable random numbers, a Manual Random Number Generator 511B (MRNG) can be presented to a user and random inputs can be provided by the user. Random inputs can include, but certainly are not limited to, mouse movement, keyboard keystrokes, visual inputs, sound inputs and the like to generate a seed number which is entered into the Manifold Seed Object (MSO) PRNG 512.

The MSO PRNG 512 takes the Manual Random Number 511A and performs an Exclusive-Oring 512B with a randomly generated number from the PRNG 512A, outputting the Manifold Seed Object (MSO) 512C. The MSO is used as the seed to the random generators used in the mathematical processes to build the Manifold Object 550 and the Surface Facets 552. Once the at least one data selection/input step is completed, computational extrapolation can begin. The Algebraic Manifold Generator 513 computes M, where the inputs can include but are not limited to origin M(x, y, z), the orientation M(θₓ, θ_{y}, θ_{z}), and dimensionality M(Rⁿ).

A process of model generation is conducted. The n-Facet Surface Mesh Generator 514 uses mathematical finite element and surface mesh algorithms to convert the smooth mathematically described manifold surface into a surface made up of planar facets, described as a Surface Facet 552. The Surface Facet 552 maximum average dimensionality is provided by a user or process input, where the facet resolution is f(xᵢ, yᵢ). Each Surface Facet can have three or more vertexes that define the surface, as represented by Expression (12). Once generated, the Surface Facets and defining properties are stored in the Manifold Table Object 551 as described herein above in the exemplary embodiment shown in FIG. 17.

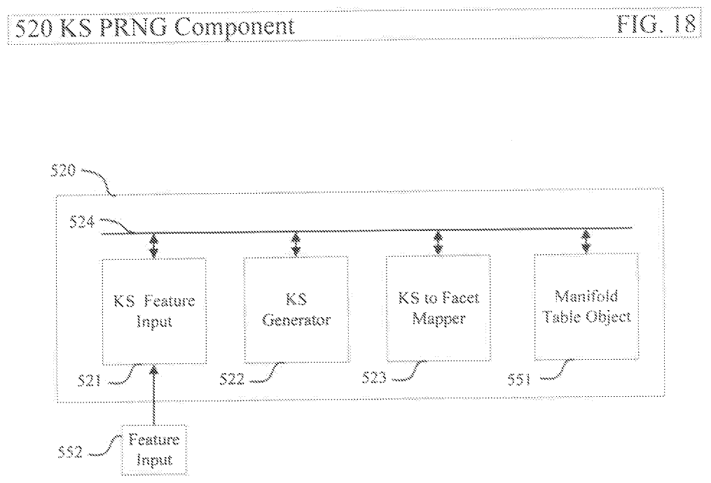

FIG. 18 is a view showing an exemplary embodiment of the KS pseudo-random number generating component. The figure shows a non-limiting example of a KS PRNG Component as shown in FIG. 1. The KS PRNG Component 520 generates unique Key Seeds (KS) 553 for each Surface Facet 552 in the Manifold Table Object 551. The exemplary embodiment of the component can include but is not limited to an at least one KS Feature Input 521, an at least one KS Generator 552, at least one KS to Facet Mapper 553, and a process communication bus 524. Additional processes can be included without departing from the spirit of the invention. The Manifold Table Object 551 is accessible by the component to read the Surface Facet table, for storing the associated KS and for other data without departing from the spirit of the invention.

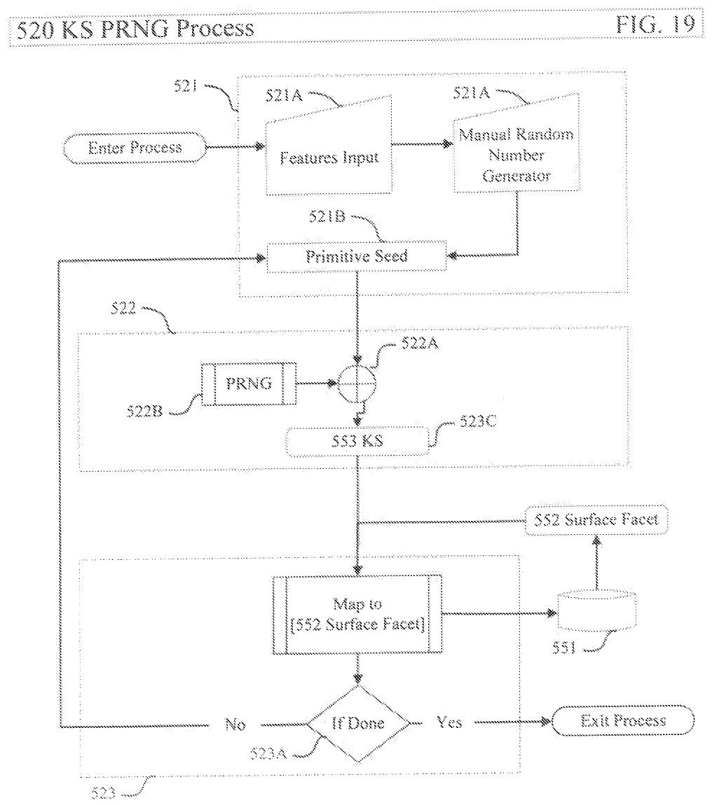

FIG. 19 is a process flow chart for an exemplary embodiment of the KS pseudo-random number generating process of FIG. 18. The process flow illustrates the respective exemplary embodiments of the KS PRNG Process. This is a process to randomly generate key seed data elements. As seen in FIG. 19, the process enters at the KS Feature Input 521, which provides the user or process a UX/UI. In order to prevent Pseudorandom Number Generator (PRNG) process from generating predicable random numbers, a Manual Random Number Generator 521A (MRNG) is presented to a user and random inputs can be provided by the user. Random inputs can include, but certainly are not limited to, mouse movement, keyboard keystrokes, visual inputs, sound inputs and the like to generate the Primitive Seed 521B which is entered into the KS Generating 522 process.

The Primitive Seed 521B is an unknown value of kLen. AES256 cryptographic key has a Kᵢ kLen of 256 bits. The KS Generating 522 process takes the Primitive Seed 521B and performs an Exclusive-Oring 522A with a randomly generated number from the PRNG 522B, outputting a KS 553. The KS to Facet Mapper 523 maps each KS to a Surface Facet 552 stored in the Manifold Table Object 551. This process repeats 523A until all Surface Facets 552 have a uniquely assigned KS 553.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. can be present without falling outside the scope of the corresponding claim or recitation. As used herein, when the phrase “at least” is used as the transition term in, for example, a preamble of a claim, it is open-ended in the same manner as the term “comprising” and “including” are open ended.

To the extent that processes are indicated, the relative order and execution to the process is non-limiting in its explanation as an example and additional steps or process can be included in the overall process without departing from the spirit of the invention whilst reading on to the steps enumerated in the claims of the invention. As would be understood by one of ordinary skill in the invention.

The embodiments and examples discussed herein are non-limiting examples. The invention is described in detail with respect to preferred embodiments, and it will now be apparent from the foregoing to those skilled in the art that changes, and modifications can be made without departing from the invention in its broader aspects, and the invention, therefore, as defined in the claims is intended to cover all such changes and modifications as fall within the true spirit of the invention.

What is claimed is:

1. A system for securing a Data Object (DO) as a Protected Data Object (PDO) in a battlespace management system (BMS) or as a subsystem of the BMS or as a component of one or more elements being managed by the BMS by encrypting the DO with an asymmetric ephemeral cryptographic key (Kᵢ) having precomputable stored components to recalculate Kᵢ during decryption, the system comprising:
an at least one server;
an at least one client device;
an at least one communications network or data transport connecting electronically the server and client device;
an at least one encryption/decryption engine residing on at least one of the at least one server, the at least one client device and the network, the encryption/decryption engine including;
an at least one digital manifold;
an at least one quadratic surface;
a unique surface perpendicular point (SPP) solution through the interaction of the at least one digital manifold and the at least one quadratic surface to generate an at least one set of identifiers including an at least one polynomial/quadratic equation coefficient (PQC) and an initial key seed value to solve for the unique SPP, wherein the solution of the SPP and the at least one set of identifiers in conjunction with the at least one manifold and the quadratic surface results in a unique solution for Kᵢ which encrypts the at least one DO to become the at least one PDO and whereby Kᵢ is rendered unavailable after the encryption process and the at least one set of identifiers is stored securely to be used to deterministically recompute the Kᵢ on demand for decryption.

2. The system of claim 1, wherein after the encryption is completed the at least one set of identifiers for Kᵢ is stored securely apart from one another and accessed to deterministically recompute Kᵢ on demand for decryption.

3. The system of claim 1, wherein the PDO includes at least one set of policies stored with the PDO for decryption.

4. The system of claim 3, wherein the at least one set of policies is checked prior to decryption.

5. The system of claim 3, wherein the at least one set of policies refer to a block chain element.

6. The system of claim 1, wherein the at least one set of identifiers includes component keys K₁, K₂ and K₃ derived respectively from the at least one PQC, the SPP, and the at least one initial key seed, and said component keys are stored as at least one of the at least one set of identifiers.

7. The system The system of claim 1, wherein the quadratic surface is one of a circle, ellipse, parabola, or hyperbola if in two dimensions or one of a sphere, ellipsoid or other surface if in three dimensions.

8. The system of claim 7, wherein the quadratic is a sphere having radius and a center point defined by radius value and a set of values for a center.

9. The system of claim 1, wherein the manifold is at least one of a sphere, a torus, a Klein bottle, or other surface manifold.

10. A circuit board having an at least one ASIC thereon and having a communications bus or coupled to a communications bus, wherein the ASIC is configured to communicate with and receive instructions from an operating system and provide a key provisioning system to a cryptographic system communicating with the operating system in a battlespace management system (BMS) or as a subsystem of the BMS or as a component of one or more elements being managed by the BMS, comprising:
means for transmitting a data object for encryption or a protected data object for decryption to the circuit board through the communications bus;
an encryption/decryption engine;
a transient cryptographic key generator including a three-dimensional manifold engine and an at least one manifold table stored on the ASIC and calculating an at least one transient key sub-component an thereby further calculating a transient cryptographic key and communicating these values and the calculated transient encryption key with/to the encryption/decryption engine, wherein the circuit board ASIC is configured to communicate with the operating system via an encryption call through the transmission means to provide the transient cryptographic key to the encryption engine to encrypt the data object or via a decryption call through the transmission means for a previously encrypted protected data object and calculate with the three-dimensional manifold engine a transient encryption key and key sub-components for the encryption/decryption engine to process the data object into an encrypted protected data object or to decrypt the previously encrypted protected data object using the transient key and key sub-components, then rendering the transient key unavailable.

11. An electronic device having a processor circuit configured to run an operating system and a communications bus, the processor circuit further configured to communicate with and receive instructions from the operating system and provide a key provisioning system to a cryptographic system communicating with the operating system, comprising:
means for transmitting a data object for encryption or a protected data object for decryption to the circuit board through the communications bus;
an encryption/decryption engine;
a circuit configured to provision a transient cryptographic key by generating an at least one manifold table having manifold data identifying the manifold, calculating an at least one transient key sub-component, and utilizing the at least one transient key subcomponent to generate a solution from the manifold table data and thereby further calculating a transient cryptographic key and communicating these values and the calculated transient encryption key to the encryption/decryption engine, wherein the processor circuit is configured to communicate with the operating system via an encryption call through the transmission means to provide the transient cryptographic key to the encryption engine to encrypt a data object or via a decryption call through the transmission means for a previously encrypted protected data object and calculate with the manifold the transient encryption key and at least one key sub-components for the encryption/decryption engine to process the data object into an encrypted protected data object or to decrypt the previously encrypted protected data object using the transient key and at least one key sub-components, then rendering the transient key unavailable.

12. The electronic device of claim 11, wherein the processor generating the manifold is further configured to process a request and select a specific three dimensional manifold from several such manifolds stored within the processor as the data in the at least one manifold table and thereby an at least one manifold table object representing a manifold surface for the manifold, the manifold surface having one or more facets thereon.

13. The electronic device of claim 12, wherein the at least one manifold table is related to the manifold and stored on the processor circuit and a random number generator generating randomly an initial key seed as a value is provided and then uses the initial key seed value to determine an at least one facet on the manifold surface from the at least one manifold table object.

14. The electronic device of claim 13, wherein the processor circuit is further configured to calculate the transient cryptographic key using the requested specific three dimensional manifold and the initial key seed and the initial key seed value to locate a facet location on the three dimensional manifold.

15. The electronic device of claim 11, wherein the processor circuit is further configured to calculate a polynomial or quadratic equation with an at least one polynomial or quadratic equation coefficient data block.

16. The electronic device of claim 15, wherein the processor circuit is further configured to locate a center of the calculated polynomial or quadratic equation based on the at least one polynomial or quadratic equation coefficient data block.

17. The electronic device of claim 16, wherein the processor circuit is further configured to solve for an at least one surface intersection point whereby the at least one polynomial or quadratic equation and the surface represented by the at least one polynomial or quadratic equation is solved at a selected facet location such that the at least one surface intersection point is calculated at an interface of the at least one polynomial or quadratic equation and the manifold object providing a defined solution set for the surface intersection point.

18. The electronic device of claim 17, wherein the processor circuit is further configured to provision the surface intersection point solution set in combination with the key seed and the polynomial quadratic coefficients to generate the transient encryption key

19. The electronic device of claim 11, wherein the encryption/decryption engine encrypts the data object into a protected data object or decrypts the previously encrypted protected data object into a data object using the generated transient encryption key.

20. The electronic device of claim 19, wherein the encryption/decryption is configured to render the key unavailable and unretrievable as a unitary key without an at least one key identifier.

21. The electronic device of claim 20, wherein the at least one key identifier is at least one of the polynomial or quadratic coefficient data block, the key seed, and the surface intersection point.

22. The electronic device of claim 21, wherein the at least one key identifier is the polynomial or quadratic coefficient data block.

23. The electronic device of claim 20, wherein the encryption/decryption engine is configured to render the key unavailable and unretrievable as a unitary key and is configured so that when it provisions the transient key it passes at least one of the polynomial or quadratic coefficient, the key seed, and the surface intersection point through a hash function as part of the process of rendering the key unavailable.

24. The electronic device of claim 18, wherein the surface intersection point is one of a tangent point or perpendicular point between the surface and the manifold.

25. The electronic device of claim 24, wherein surface intersection point is a perpendicular intersection solution for a selected point on the facet surface on the manifold relative to polynomial or quadratic equation.
